(19) United States
(12) Patent Application Publication
(10) Pub. No.: US 2024/0080097 A1
(43) Pub. Date: Mar. 7, 2024

(54) LIFI DISTRIBUTION MODULE WITH SANITIZATION

(71) Applicant: Alex King, Las Cruces, NM (US)

(72) Inventor: Alex King, Las Cruces, NM (US)

(21) Appl. No.: 18/259,570

(22) PCT Filed: Dec. 27, 2021
(86) PCT No.: PCT/US2021/065245

§ 371 Date: Jun. 27, 2023

(51) Int. Cl. H04B 10/114

(52) U.S. Cl. CPC H04B 10/114

(57) ABSTRACT

The disclosed embodiments comprise a system, method and apparatus comprising a light distribution module, at least one light adaptor fixture and at least one fiber distribution line connecting the light distribution module and the at least one fiber adaptor fixture, configured for implementing LiFi in aircraft, as well as other shared transportation spaces, along with sanitization and illumination of such enclosed spaces.

### CROSS REFERENCE TO RELATED PATENT APPLICATION

This patent application claims the priority and benefit, under 35 U.S.C. § 119(e), of U.S. Provisional Patent Application Ser. No. 63/131,264, filed Dec. 28, 2020, and titled “LIFI DISTRIBUTION MODULE WITH SANITIZATION”. U.S. Provisional Application Ser. No. 63/131,264 is incorporated herein by reference in its entirety.

### TECHNICAL FIELD

Embodiments are generally related to the field of LiFi, also known as light fidelity. Embodiments are also related to the field of data communications technology. Embodiments are further related to the field of sanitization of enclosed spaces. Embodiments are also directed to methods for lighting enclosed spaces. Embodiments are also related to methods, systems, and devices for implementing LiFi in aircraft, as well as other shared transportation spaces, along with sanitization and illumination of such enclosed spaces.

### BACKGROUND

Communication technology has emerged as one of the most ubiquitous and important developments in human history. Data communication is now available in almost any location on earth, and consumers have created an ever increasing demand for higher speed data transmission. While technology has been developed to meet this need in most contexts, one notable exception is the transportation industry (such as aircraft and rail), where wireless communication signals are limited both for technological and safety reasons. Indeed, the FCC has announced that Wi-Fi is reaching a “spectrum crunch” meaning that it is close to critical capacity, and that alternatives will be required to alleviate that burden.

“Visible light communication” refers generally to the use of visible light to transmit information, a technology that has existed for more than 100 years. The term “LiFi” was coined in 2011 and refers to light fidelity systems intended to integrate modern data transfer techniques into lighting devices. However, the use of LiFi has been mostly relegated to systems and methods that make use of LED lights, which offer fairly low data throughput.

Furthermore, the role of air and surface sanitization has become increasingly important given the threat of airborne pathogens. This is acutely true in the transportation industry, where patrons are confined to spaces where sufficient social distancing and other effective sanitization methods may not be possible. It is important to note that airplanes' high-powered filtration systems are not sufficient, on their own, to prevent viral or bacterial transmission. Infected people send particles into the air at a faster rate than airplanes flush them out of the cabin. Passenger aircraft are typically equipped with HEPA filtration which promotes a frequent air exchange rate. However, it is unlikely to protect individuals that are seated in close proximity to an infected passenger.

Current cabin sanitization solutions fall short or create unintended side effects to installed surfaces and/or electrical equipment. The FAA is calling attention to risks that disinfection can have on aircraft interiors, urging operators and maintainers to heed manufacturers' guidance and take extra steps to protect sensitive equipment, wiring, and other high-risk components.

For example, the FAA has noted fogging and misting solutions, especially those which utilize the aircraft or other cabin ventilation system, allow disinfectant to penetrate areas where it could create problems, such as the corrosion of underlying structures or fan cooled electronics. Likewise, the use of mobile UV-C equipment is hazardous to human beings and can only be used to sanitize cabins prior to passenger boarding. Therefore, it is effective at maintaining a sanitized environment only until the first new passenger boards.

Implementation of data and sanitation technology is particularly difficult on aircraft. First, weight limitations severely restrict the types of systems that can practically be installed on an aircraft. In addition, aircraft safety standards also create specific limitations as to the types of electronic components that can be used on aircraft. Thus, conventional data communication and sanitation technology cannot be used on many aircraft.

Accordingly, there is a need in the art for methods and systems that address the aforementioned gaps in current technology as disclosed the embodiments detailed herein.

### SUMMARY

The following summary is provided to facilitate an understanding of some of the innovative features unique to the embodiments disclosed and is not intended to be a full description. A full appreciation of the various aspects of the embodiments can be gained by taking the entire specification, claims, drawings, and abstract as a whole.

It is, therefore, one aspect of the disclosed embodiments to provide a method, system, and apparatus for disinfecting enclosed environments.

It is another aspect of the disclosed embodiments to provide a method, system, and apparatus for data communication.

It is another aspect of the disclosed embodiments to provide a method, system, and apparatus for providing LIFI.

It is another aspect of the disclosed embodiments to provide methods and systems for sanitization of enclosed spaces.

It is another aspect of the disclosed embodiments to provide lighting for enclosed spaces.

In additional embodiments, methods, systems, and devices are provided for implementing LiFi in aircraft, as well as other shared transportation spaces, along with sanitization and illumination of such enclosed spaces.

The aforementioned aspects and other objectives and advantages can now be achieved as described herein. In an exemplary embodiment, a system comprises a light distribution module, at least one light adaptor fixture, and at least one fiber distribution line connecting the light distribution module and the at least one fiber adaptor fixture. In an embodiment, the light distribution module further comprises: a communication input board; a data processing module, a LiFi photocell input, and a LiFi and sanitation output module.

In an embodiment, the at least one fiber distribution line further comprises a transport fiber. In an embodiment, the system comprises at least one wash light emissive fiber.

In an embodiment the at least one fiber adaptor fixture further comprises a collimator attached to the at least one fiber distribution line, an adaptor coupling the collimator to at least one light emitting diode, and a housing for the collimator, the adaptor, and the light emitting diode. In an embodiment the system comprises a photo detector on the housing. In an embodiment, at least one light emitting diode comprise a Far-UVC Emitter. In an embodiment, the at least one light emitting diode comprises a Nano LED. In an embodiment, the at least one light emitting diode comprise an infrared light. In an embodiment the system comprises at least one photocell. In an embodiment, the system comprises a server operably connected to the light distribution module.

In another embodiment a system for data communication comprises a light distribution module, at least one light adaptor fixture configured in the cabin of an aircraft, at least one fiber distribution line connecting the light distribution module and the at least one fiber adaptor fixture, a server operably connected to the light distribution module, at least one transport fiber, and at least one wash light emissive fiber.

In an embodiment the light distribution module further comprises a communication input board; a data processing module, a LiFi photocell input, and a LiFi and sanitation output module. In an embodiment at least one fiber adaptor fixture further comprises a collimator attached to the at least one fiber distribution line, an adaptor coupling the collimator to at least one light emitting diode, and a housing for the collimator, the adaptor, and the light emitting diode. In an embodiment, at least one light emitting diode comprise at least one of: a Far-UVC Emitter and a Nano LED.

In an embodiment, a data communication system for providing light in an enclosed environment comprises a light distribution module comprising a communication input board, a data processing module, a LiFi photocell input, and a LiFi and sanitation output module, at least one light adaptor fixture further comprising a collimator attached to the at least one fiber distribution line, an adaptor coupling the collimator to at least one light emitting diode, and a housing for the collimator, the adaptor, and the light emitting diode and at least one fiber distribution line connecting the light distribution module and the at least one fiber adaptor fixture. In an embodiment, the at least one fiber distribution line further comprises a transport fiber. In an embodiment the system further comprises at least one wash light emissive fiber. In an embodiment the system comprises a photo detector on the housing. In an embodiment the enclosed environment comprises the cabin of an aircraft.

### BRIEF DESCRIPTION OF THE DRAWINGS

The accompanying figures, in which like reference numerals refer to identical or functionally-similar elements throughout the separate views and which are incorporated in and form a part of the specification, further illustrate the embodiments and, together with the detailed description, serve to explain the embodiments disclosed herein.

FIG. 1 depicts a block diagram of a computer system which is implemented in accordance with the disclosed embodiments;

FIG. 2 depicts a graphical representation of a network of data-processing devices in which aspects of the present embodiments may be implemented;

FIG. 3 depicts a computer software system for directing the operation of the data-processing system depicted in FIG. 1, in accordance with an embodiment;

FIG. 4 depicts a block diagram of a data communications, illumination, and sanitization system, in accordance with the disclosed embodiments;

FIG. 5A depicts aspects of a light distribution module, in accordance with the disclosed embodiments;

FIG. 5B depicts aspects of another embodiment of a light distribution module, in accordance with the disclosed embodiments;

FIG. 6 depicts aspects of a light adaptor fixture, in accordance with the disclosed embodiments;

FIG. 7 depicts a diagram of exemplary system architecture for a data communications, illumination, and sanitization system, in accordance with the disclosed embodiments;

FIG. 8 depicts a diagram of exemplary system architecture for a data communications, illumination, and sanitization system, in accordance with the disclosed embodiments;

FIG. 9 depicts another embodiment of a light adaptor fixture, in accordance with the disclosed embodiments;

FIG. 10 depicts a modular LiFi sanitization system, in accordance with the disclosed embodiments;

FIG. 11 depicts a diagram of exemplary system architecture for a modular LiFi sanitization system, in accordance with the disclosed embodiments;

FIG. 12A depicts an inline driver/access point system, in accordance with the disclosed embodiments;

FIG. 12B depicts aspects of an inline driver/access point system, in accordance with the disclosed embodiments;

FIG. 12C depicts aspects of an inline driver/access point module, in accordance with the disclosed embodiments;

FIG. 12D depicts system architecture of an inline driver/access point system, in accordance with the disclosed embodiments;

FIG. 13 depicts aspects of a dongle, in accordance with the disclosed embodiments;

FIG. 14 depicts steps in a method for data communications, illumination, and sanitization in an enclosed environment, in accordance with the disclosed embodiments;

FIG. 15A depicts aspects of a Far-UVC module, in accordance with the disclosed embodiments; and

FIG. 15B depicts aspects of another embodiment of a Far-UVC module, in accordance with the disclosed embodiments.

### DETAILED DESCRIPTION

The particular values and configurations discussed in the following non-limiting examples can be varied, and are cited merely to illustrate one or more embodiments and are not intended to limit the scope thereof.

Example embodiments will now be described more fully hereinafter, with reference to the accompanying drawings, in which illustrative embodiments are shown. The embodiments disclosed herein can be embodied in many different forms and should not be construed as limited to the embodiments set forth herein; rather, these embodiments are provided so that this disclosure will be thorough and complete, and will fully convey the scope of the embodiments to those skilled in the art. Like numbers refer to like elements throughout.

The terminology used herein is for the purpose of describing particular embodiments only and is not intended to be limiting. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It is contemplated that any embodiment discussed in this specification can be implemented with respect to any method, kit, reagent, or composition of the invention, and vice versa. Furthermore, compositions of the invention can be used to achieve methods of the invention.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents are considered to be within the scope of this invention and are covered by the claims.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

All of the compositions and/or methods disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and in the steps or in the sequence of steps of the method described herein without departing from the concept, spirit and scope of the invention. All such similar substitutes and modifications apparent to those skilled in the art are deemed to be within the spirit, scope and concept of the invention as defined by the appended claims.

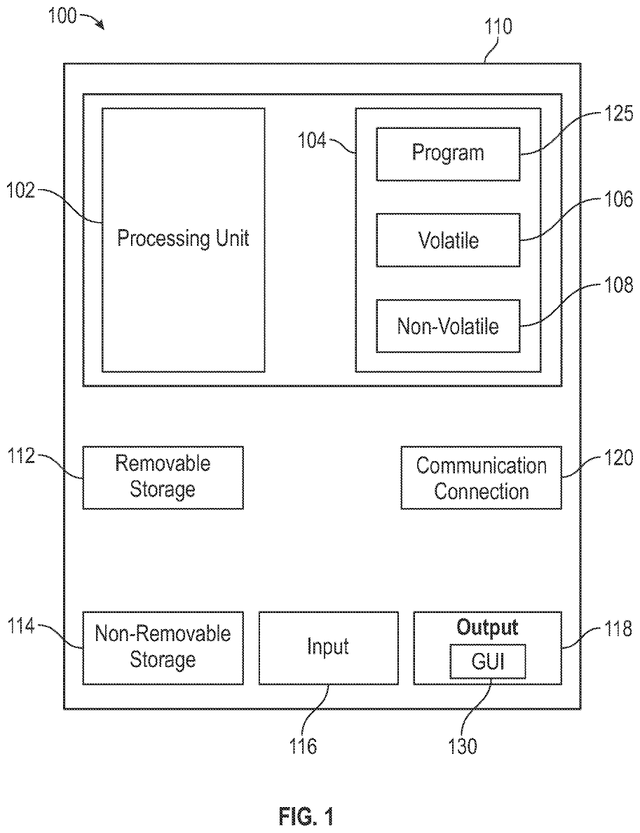

FIGS. 1-3 are provided as exemplary diagrams of data-processing environments in which embodiments of the present invention may be implemented. It should be appreciated that FIGS. 1-3 are only exemplary and are not intended to assert or imply any limitation with regard to the environments in which aspects or embodiments of the disclosed embodiments may be implemented. Many modifications to the depicted environments may be made without departing from the spirit and scope of the disclosed embodiments.

A block diagram of a computer system 100 that executes programming for implementing parts of the methods and systems disclosed herein is shown in FIG. 1. A computing device in the form of a computer 110 configured to interface with sensors, peripheral devices, and other elements disclosed herein may include one or more processing units 102, memory 104, removable storage 112, and non-removable storage 114. Memory 104 may include volatile memory 106 and non-volatile memory 108. Computer 110 may include or have access to a computing environment that includes a variety of transitory and non-transitory computer-readable media such as volatile memory 106 and non-volatile memory 108, removable storage 112 and non-removable storage 114. Computer storage includes, for example, random access memory (RAM), read only memory (ROM), erasable programmable read-only memory (EPROM) and electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage, or other magnetic storage devices, or any other medium capable of storing computer-readable instructions as well as data including image data.

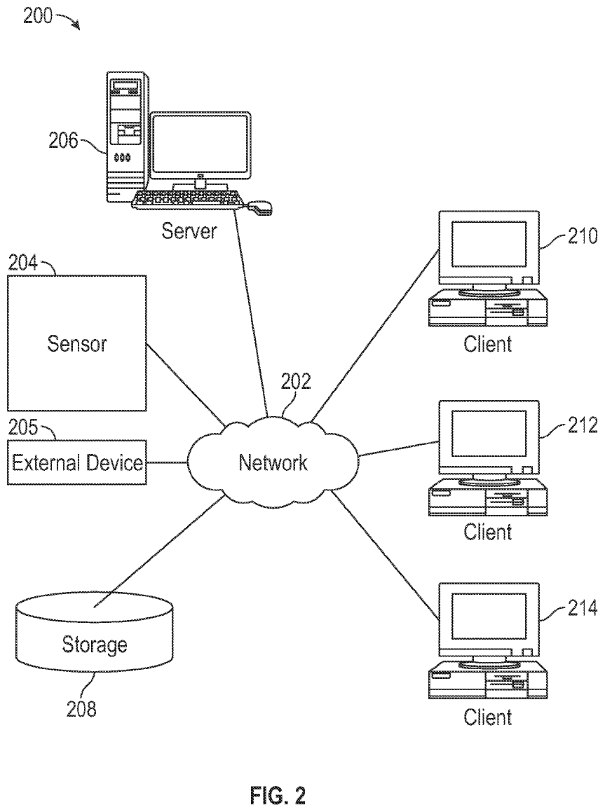

Computer 110 may include or have access to a computing environment that includes input 116, output 118, and a communication connection 120. The computer may operate in a networked environment using a communication connection 120 to connect to one or more remote computers, remote sensors, detection devices, hand-held devices, multifunction devices (MFDs), mobile devices, tablet devices, mobile phones, Smartphones, or other such devices. The remote computer may also include a personal computer (PC), server, router, network PC, RFID enabled device, a peer device or other common network node, or the like. The communication connection may include a Local Area Network (LAN), a Wide Area Network (WAN), Bluetooth connection, or other networks. This functionality is described more fully in the description associated with FIG. 2 below.

Output 118 is most commonly provided as a computer monitor, but may include any output device. Output 118 and/or input 116 may include a data collection apparatus associated with computer system 100. In addition, input 116, which commonly includes a computer keyboard and/or pointing device such as a computer mouse, computer track pad, or the like, allows a user to select and instruct computer system 100. A user interface can be provided using output 118 and input 116. Output 118 may function as a display for displaying data and information for a user, and for interactively displaying a graphical user interface (GUI) 130.

Note that the term “GUI” generally refers to a type of environment that represents programs, files, options, and so forth by means of graphically displayed icons, menus, and dialog boxes on a computer monitor screen. A user can interact with the GUI to select and activate such options by directly touching the screen and/or pointing and clicking with a user input device 116 such as, for example, a pointing device such as a mouse and/or with a keyboard. A particular item can function in the same manner to the user in all applications because the GUI provides standard software routines (e.g., module 125) to handle these elements and report the user's actions. The GUI can further be used to display the electronic service image frames as discussed below.

Computer-readable instructions, for example, program module or node 125, which can be representative of other modules or nodes described herein, are stored on a computer readable medium and are executable by the processing unit 102 of computer 110. Program module or node 125 may include a computer application. A hard drive, CD-ROM, RAM, Flash Memory, and a USB drive are just some examples of articles including a computer-readable medium.

FIG. 2 depicts a graphical representation of a network of data-processing systems 200 in which aspects of the present invention may be implemented. Network data-processing system 200 is a network of computers or other such devices such as mobile phones, smartphones, sensors, detection devices, and the like in which embodiments of the present invention may be implemented. Note that the system 200 can be implemented in the context of a software module such as program module 125. The system 200 includes a network 202 in communication with one or more clients 210, 212, and 214, and external device 205. Network 202 may also be in communication with one or more RFID and/or GPS enabled devices or sensors 204, servers 206, and storage 208. Network 202 is a medium that can be used to provide communications links between various devices and computers connected together within a networked data processing system such as computer system 100. Network 202 may include connections such as wired communication links, wireless communication links of various types, fiber optic cables, quantum, or quantum encryption, or quantum teleportation networks, etc. Network 202 can communicate with one or more servers 206, one or more external devices such as RFID and/or GPS enabled device 204, and a memory storage unit such as, for example, memory or database 208. It should be understood that RFID and/or GPS enabled device 204 may be embodied as a mobile device, cell phone, tablet device, monitoring device, detector device, sensor microcontroller, controller, receiver, transceiver, or other such device.

In the depicted example, RFID and/or GPS enabled device 204, server 206, and clients 210, 212, and 214 connect to network 202 along with storage unit 208. Clients 210, 212, and 214 may be, for example, personal computers or network computers, handheld devices, mobile devices, tablet devices, smartphones, personal digital assistants, microcontrollers, recording devices, MFDs, etc. Computer system 100 depicted in FIG. 1 can be, for example, a client such as client 210 and/or 212.

Computer system 100 can also be implemented as a server such as server 206, depending upon design considerations. In the depicted example, server 206 provides data such as boot files, operating system images, applications, and application updates to clients 210, 212, and/or 214. Clients 210, 212, and 214 and RFID and/or GPS enabled device 204 are clients to server 206 in this example. Network data-processing system 200 may include additional servers, clients, and other devices not shown. Specifically, clients may connect to any member of a network of servers, which provide equivalent content.

In the depicted example, network data-processing system 200 is the Internet with network 202 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers consisting of thousands of commercial, government, educational, and other computer systems that route data and messages. Of course, network data-processing system 200 may also be implemented as a number of different types of networks such as, for example, an intranet, a local area network (LAN), or a wide area network (WAN). FIGS. 1 and 2 are intended as examples and not as architectural limitations for different embodiments of the present invention.

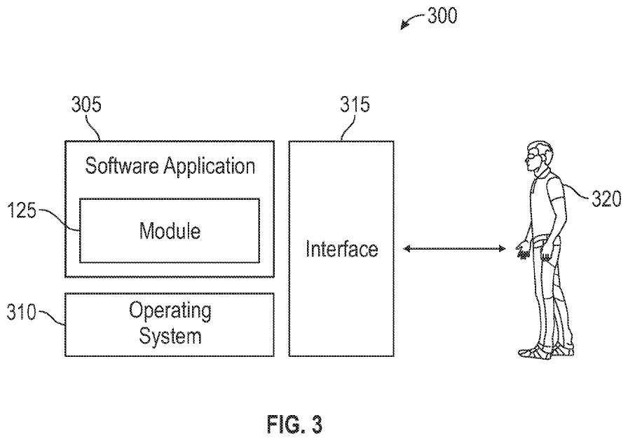

FIG. 3 illustrates a software system 300, which may be employed for directing the operation of the data-processing systems such as computer system 100 depicted in FIG. 1. Software application 305, may be stored in memory 104, on removable storage 112, or on non-removable storage 114 shown in FIG. 1, and generally includes and/or is associated with a kernel or operating system 310 and a shell or interface 315. One or more application programs, such as module(s) or node(s) 125, may be “loaded” (i.e., transferred from removable storage 114 into the memory 104) for execution by the data-processing system 100. The data-processing system 100 can receive user commands and data through user interface 315, which can include input 116 and output 118, accessible by a user 320. These inputs may then be acted upon by the computer system 100 in accordance with instructions from operating system 310 and/or software application 305 and any software module(s) 125 thereof.

Generally, program modules (e.g., module 125) can include, but are not limited to, routines, subroutines, software applications, programs, objects, components, data structures, etc., that perform particular tasks or implement particular abstract data types and instructions. Moreover, those skilled in the art will appreciate that elements of the disclosed methods and systems may be practiced with other computer system configurations such as, for example, hand-held devices, mobile phones, smart phones, tablet devices, multiprocessor systems, printers, copiers, fax machines, multi-function devices, data networks, microprocessor-based or programmable consumer electronics, networked personal computers, minicomputers, mainframe computers, servers, medical equipment, medical devices, and the like.

Note that the term “program module” or “node” as utilized herein may refer to a collection of routines and data structures that perform a particular task or implements a particular abstract data type. Program modules may be composed of two parts: an interface, which lists the constants, data types, variables, and routines that can be accessed by other program modules or routines; and an implementation, which is typically private (accessible only to that program module) and which includes source code that actually implements the routines in the program module. The term “module” may also simply refer to an application such as a computer program designed to assist in the performance of a specific task such as word processing, accounting, inventory management, etc., or a hardware component designed to equivalently assist in the performance of a task.

The interface 315 (e.g., a graphical user interface 130) can serve to display results, whereupon a user 320 may supply additional inputs or terminate a particular session. In some embodiments, operating system 310 and GUI 130 can be implemented in the context of a “windows” system. It can be appreciated, of course, that other types of systems are possible. For example, rather than a traditional “windows” system, other operation systems such as, for example, a real time operating system (RTOS) more commonly employed in wireless systems may also be employed with respect to operating system 310 and interface 315. The software application 305 can include, for example, module(s) 125, which can include instructions for carrying out steps or logical operations such as those shown and described herein.

The following description is presented with respect to embodiments of the present invention, which can be embodied in the context of, or require the use of a data-processing system such as computer system 100, in conjunction with program module 125, and data processing system 200 and network 202 depicted in FIGS. 1-3. The present invention, however, is not limited to any particular application or any particular environment. Instead, those skilled in the art will find that the systems and methods of the present invention may be advantageously applied to a variety of system and application software including database management systems, word processors, and the like. Moreover, the present invention may be embodied on a variety of different platforms including Windows, Macintosh, UNIX, LINUX, Android, Arduino and the like. Therefore, the descriptions of the exemplary embodiments, which follow, are for purposes of illustration and not considered a limitation.

Various aspects of the disclosed systems and methods can include software, embodied as software or program modules, and implemented using the disclosed systems. The software modules can provide interfaces to existing Cabin Management Systems (CMS)/In-flight Entertainment Systems (IFE), or other such lighting control systems, for control of lighting. Communication languages for such systems can include RS232, RS485, Ethernet, CanBus, and other proprietary languages which may be integrated. Further, software modules can be used to modulate lighting based on the data being transmitted/received by a network (i.e., encoding/decoding data).

In additional embodiments, mobile software application or “apps” comprising mobile communication software can be provided, that take advantage of native LiFi capabilities built into mobile devices to encode/decode data, as opposed to requiring a dongle. This can include Optical Camera Communications (which use devices such as cameras). Network diagnostics software modules can also be used for diagnostic routines.

The embodiments disclosed herein are directed to a system for distributing light, LiFi data connectivity, and/or sanitization. A light distribution module associated with the system disclosed herein, can be installed primarily on aircraft, but could also be installed on trains, buses, and other modes of transportation as well as other enclosed environments. The light distribution module can distribute light, sanitization, and LiFi connectivity via transport fibers. The transport fibers can interface with mechanical housings which can replace existing lights. These housings can be designed around the existing light's mounting provisions to be drop-in replacements to simplify installation. Transport fibers may also be emissive, in that light entering the fiber is projected instantly throughout the entire fiber length. This emissive fiber light can be used as wash lighting on walls, ceilings, floors, accent lights, etc.

Some or all aspects of the disclosed systems can be designed to pass applicable Radio Technical Commission for Aeronautics (RTCA) DO-160 certification guidelines for airworthiness. Tables provided herein outline design aspects of all components to meet or exceed RTCA DO-160 certification criteria.

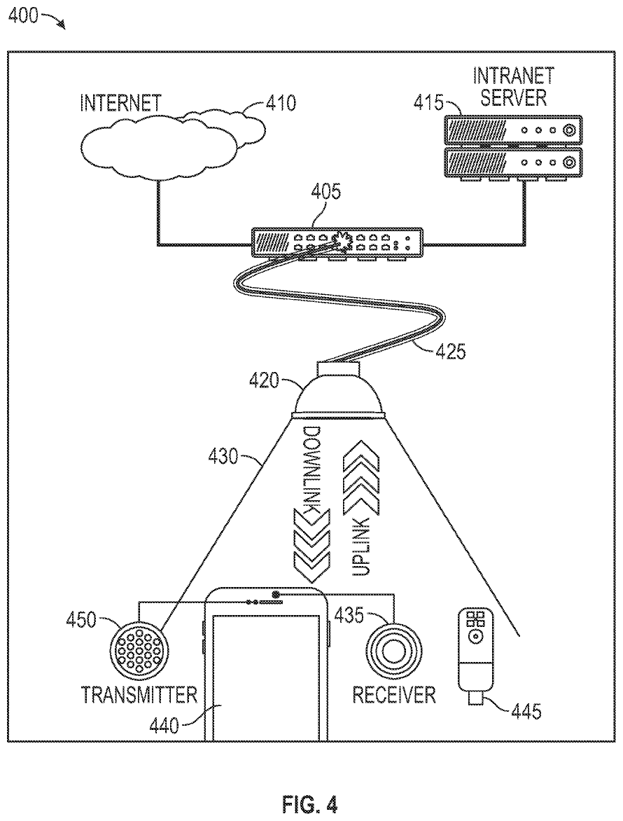

FIG. 4 illustrates a block diagram of a system 400 for providing data communications, illumination, and sanitization in accordance with the disclosed embodiments. In certain embodiments, the system 400 can comprise a light distribution module 405 which is central to the system 400. The centralized light distribution module 405 can be operably connected to the internet 410, as well as one or more intranet servers 415.

In certain embodiments, the system 400 can be installed in an aircraft, bus, train, or other such environment where it is desirable for internet connectivity to be served to one or more devices in the environment. In the case of an aircraft, the internet 410 can be served via satellite connection, cellular network connection, terrestrial connection, or other such connection. The centralized light distribution module 405 (or “light distribution module”) can be connected to at least one light adaptor fixture 420. In certain embodiments connection between the centralized light distribution module 405 and light adaptor fixture 420 can be made with fiber optic (transport or emissive) cable 425.

The centralized light distribution module 405 is configured to convert data provided by an internet 410, or intranet connection 415 into modulated light signals 430. In certain embodiments, the modulated light signals 430 can be laser light signals generated by laser surface mount devices (SMDs). The light signals 430 may be visible and non-visible (IR) light. The light adaptor fixtures 420 can be specially designed to provide modulated light to a receiver 435 associated with a mobile device 440, computing device, or external dongle 445. The mobile device 440, computing device, or external device can collect the light signals 430 and convert it into a digital signal processable by the computing device 440. Similarly, the mobile device 440 or computing device, or dongle 445 can include an optical transmitter 450 which can be used to send signals back to the light adaptor fixture 420. The optical signal 430 can then be converted into a digital signal and transmitted to other devices via the internet 410 or intranet connection 415.

As illustrated in FIG. 4, the system 400 can include a universal LiFi output 420. In certain embodiments the output 420 can provide up to 224 GB/s and can be embodied as a read, ceiling, or wash light. The system 400 offers lightweight fiber 425 distribution throughout an aircraft cabin, train, bus, or other such environment. The fiber cables 425 and architecture can meet industry standards and can include fiber terminations in addition to the fiber itself.

Fiber terminations/feed-throughs can be distributed throughout the environment, through walls, etc. The distribution module 405 further includes a high quality laser that provides general high quality laser light illumination. This can include dual channel SMD with infrared wavelengths. The dual channel Laser SMD provides data over visible light, and invisible light via the Infrared channel. Infrared light maintains LiFi communication when there is no visual light so that the data communication network remains active even when the visible lights are turned off.

It should be noted that, although the system 400 can be used to provide a means of data communication, in other embodiments, the system can also be used to provide illumination and/or sanitization only. That is to say, in certain embodiments, the fiber architecture can be used to distribute lighting and sanitization throughout the cabin of an aircraft, or other such environment. In such embodiments, the centralized light distribution module 405 outputs 420 can be routed to one or more mechanical housings that can be distributed throughout the cabin. The mechanical housings can include, for example, a Circuit Card Assembly (CCA) with LEDs driven by an auxiliary/emergency discrete input. As in other embodiments, an emissive fiber can be connected to the output to provide a wash lighting effect throughout the cabin (or other such environment).

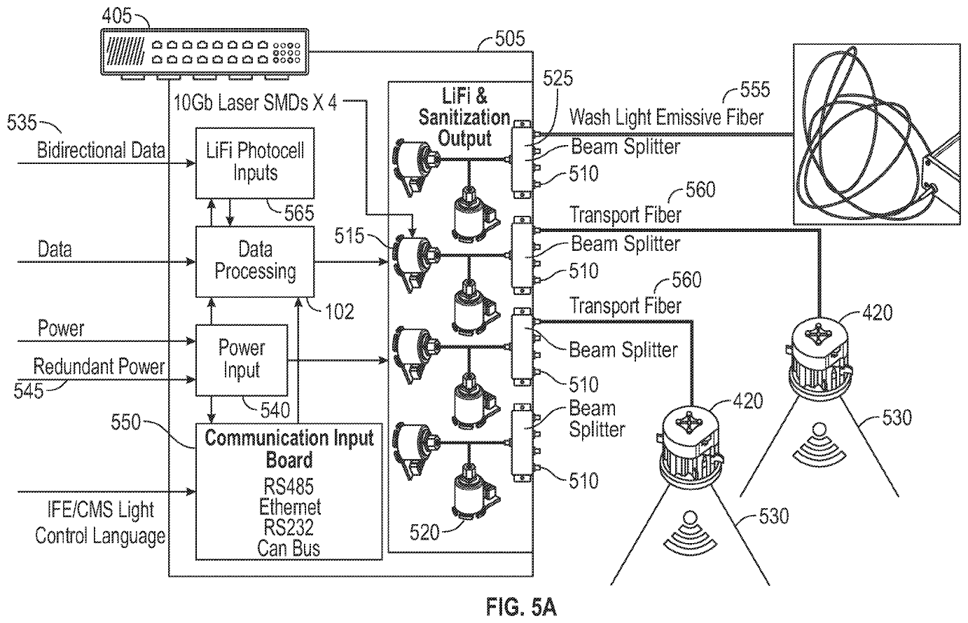

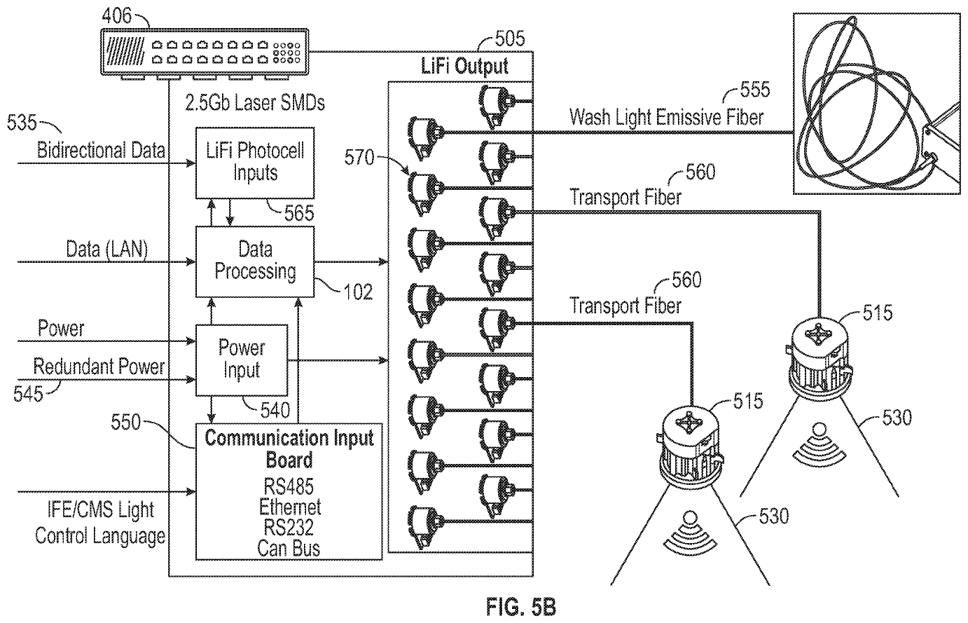

The centrally located light distribution module 405 is detailed in FIG. 5A. The light distribution module 405 illustrated in FIG. 5A includes a number of exemplary aspects. It should be appreciated that numbers, illustrative of speeds, or the number of certain components as provided are meant to be exemplary and other numbers of devices/modules etc. can also be used. The light distribution module 405 includes a housing 505 with, for example, 16 fiber coupled outputs 510 which house a plurality of, for example, 10 GB Laser SMDs 515 along with at least one sanitization laser SMD 520 that is directed through fiber beam splitters 525 providing various outputs 530 at, for example, 2.5 GB/s each. It should be appreciated that in other embodiments, more or fewer outputs can be used. For example, in other embodiments there can be 4 outputs, 8 outputs, etc. The housing 505 can be made of a metal such as aluminum, or of a thermoplastic, in order to provide protection against flammability. In other embodiments, any other metal component disclosed herein can also be made of thermoplastic.

The Laser SMDs 515 can comprise a high-powered blue laser used to illuminate a phosphor resulting in safe, bright white light that can be “warmed” via filters and optics. The sanitization SMD is configured such that the laser provides a different wavelength of light that can be used to destroy pathogens. These wavelengths can be: 405 nm (UVV-UVA range), 226 nm-280 nm (UVC), 200 nm-225 nm (FAR-UVC), and/or 100 nm-200 nm (Vacuum UVC).

The centrally located light distribution module 405 can have several inputs/outputs which can include, but are not limited to, network connections, bidirectional LiFi data input/output 535, power input 540 with redundant power input 545 for failover, CMS/IFE lighting control input 550 (which supports common CMS/IFE control languages), Ethernet, RS232, RS485, and CanBus. The driver portion takes the incoming network data and modulates the light output to send that data to receivers which can be distributed throughout the cabin. This can be completed at each of the output ports.

Bidirectional communication with the light distribution module 405 is accomplished by remotely located photocell diodes. These photocell diodes may be incorporated in the fiber termination mechanical device in the ceiling, or standalone ceiling or other room-located photocell diode receivers. The receivers will relay communication data back to the light distribution module 405.

The centrally located light distribution module 405 can include beam splitters 525 which include wash light emissive fiber 555, as well as transport fiber 560 connecting the LiFi sanitization output module to light adaptor fixtures 420. The light adaptor fixtures 420 can comprise mechanical housings that can be located throughout the cabin.

As detailed herein, LiFi photocell input 565 provides an input into the system (i.e., bidirectional data). The data, which may be standard network data, is converted in the LiFi module and transmitted back onto the network. The power inputs are used to power the LiFi module, which utilizes a redundant power input in case of power failure on the other line. CMS/IFE control language provides a means of controlling the light (i.e., dimming etc..) via the existing CMS/IFE system. Each output can be controlled independently of the other.

Another embodiment of the centrally located light distribution module 406 is detailed in FIG. 5B. The light distribution module 406 illustrated in FIG. 5B includes a number of exemplary aspects. It should be appreciated that numbers, illustrative of speeds, or the number of certain components as provided are meant to be exemplary and other numbers of devices/modules etc. can also be used.

In this embodiment, the Laser SMDs and splitters have been removed in favor of individual 2.5 Gbps laser SMD 570. It should be appreciated that in other embodiments, more or fewer outputs can be used. For example, in other embodiments there can be more or fewer laser SMD's 570 without departing from the disclosure herein. The Laser SMDs 570 can comprise a high-powered blue laser used to illuminate a phosphor resulting in safe, bright white light that can be “warmed” via filters and optics. It should be noted that, in certain embodiments, the sanitization SMD can be removed.

The centrally located light distribution module 406 can have several inputs/outputs which can include, but are not limited to, network connections, bidirectional LiFi data input/output 535, power input 540 with redundant power input 545 for failover, CMS/IFE lighting control input 550 (which supports common CMS/IFE control languages), Ethernet, RS232, RS485, and CanBus. The driver portion takes the incoming network data and modulates the light output to send that data to receivers which can be distributed throughout the cabin. This can be completed at each of the output ports.

Bidirectional communication with the light distribution module 406 is accomplished by remotely located photocell diodes. These photocell diodes may be incorporated in the fiber termination mechanical device in the ceiling, or standalone ceiling or other room-located photocell diode receivers. The receivers will relay communication data back to the light distribution module 406.

The centrally located light distribution module 406 can include wash light emissive fiber 555, as well as transport fiber 560 connecting to light adaptor fixtures 420. The light adaptor fixtures 420 can comprise mechanical housings that can be located throughout the cabin.

As detailed herein, LiFi photocells provide an input into the system (i.e., bidirectional data). The data, which may be standard network data, is converted in the LiFi module and transmitted back onto the network. The power inputs are used to power the LiFi module, which utilizes a redundant power input in case of power failure on the other line. CMS/IFE control language provides a means of controlling the light (i.e., dimming etc..) via the existing CMS/IFE system. Each output can be controlled independently of the other.

Various aspects of the light distribution module 405 or light distribution module 406 can be designed to meet RTCA D0160 (environmental conditions and test procedures for airborne equipment) certification requirements. These requirements are unique to the airline industry, and are established to ensure airborne vehicles are safe.

Certain of the requirements are outlined here. One example is Flammability—this applies to ALL aircraft components. The disclosed embodiment is configured to ensure all components can self-extinguish in a specific time. Components disclosed herein for aircraft are therefore selected accordingly.

Another example is regulation of power input/power filtration to protect against voltage spikes. This requirement applies to all the disclosed electrical circuits on aircraft. The circuitry has to be able to handle power input spikes, including spikes from lighting strikes etc.. which requires power filtering components that absorb the variations to avoid damaging the circuitry. In addition, as power is switched from the ground cart, to the auxiliary power unit (APU) of the aircraft, and eventually to the aircraft engines all those transitions can cause power issues. The disclosed airworthy components must be designed to handle those transitions. As such “hold up” power is built into the devices to overcome the transitions.

Another example is crash safety which again applies to all the disclosed aircraft components. Crash safety testing relates to the integrity of the mechanical design of the disclosed components to ensure they can meet/sustain specific G Load forces without failure.

Another example is temperature control which applies to all the disclosed aircraft components. Airworthy components can be designed to handle temperature fluctuations experienced during air travel.

Another example is electromagnetic interference (EMI). Design requirements for airworthy components disclosed herein can be selected to mitigate and/or eliminate EMI, which could negatively impact other critical flight equipment. The disclosed, enclosures are built of aluminum with an “EMI Lip” which keeps signals from seeping out of the mechanical enclosure.

Table 1 illustrates various requirements, along with physical design aspects associated with the light distribution module intended to meet those requirements.

TABLE 1

| RTCA/DO-160G | Sub-Category | Description: 16-Port Light Distribution Unit (LDU) |
|---|---|---|
| Section 4.5.1 | Category: A1 | Design shall be aluminum enclosure with aerospace grade internal components (circuit |
| Ground Survival Low | | card assemblies, cables, connectors) designed to withstand −25 C. (non-operating). |
| Temperature | | |
| Section 4.5.2 | Category: A1 | Design shall be aluminum enclosure with aerospace grade internal components (circuit |
| Operating Low | | card assemblies, cables, connectors) designed to withstand −5 C. (operating). |
| Temperature | | |
| Section 4.5.3 | Category: A1 | Design shall be aluminum enclosure with aerospace grade internal components (circuit |
| Ground Survival High | | card assemblies, cables, connectors) designed to withstand +70 C. (non-operating). |
| Temperature | | |
| Section 4.5.4 | Category: A1 | Design shall be aluminum enclosure with aerospace grade internal components (circuit |
| Operating High | & A2 | card assemblies, cables, connectors) designed to withstand +55 C. (operating). |
| Temperature | | |
| Section 4.6.1, 4.6.2, 4.6.3 | Category: A1 | Product will not utilize any material which can be compressed or expanded with pressure |
| Altitude, Decompression, | | (such as foam, tape, plastics, etc.). |
| Overpressure | | |
| Section 6 | Category: A | Product will use a aluminum enclosure, which is not affected by humidity conditions. |
| Humidity | | Internal circuit card assemblies and connections will use materials and assembly practices |
| | | to mitigate humidity suscceptibility. |
| Section 7.2 | Category: B | Product will use mechanical design features, such as machined 6061 aluminum base with |
| Operational Shock | | machined circuit card assembly mounting points and support bosses to eliminate vibration |
| | | or mechanical distortion. |
| Section 7.3.2 | Category: B | Product will feature an integrated “one-piece” machined 6061 aluminum base with perimeter |
| Crash Safety Shock | | mounting tabs. The tabs will be a minimum of .225″ thick and accept a mounting screw such as |
| | | #10 machine screw. |
| Section 7.3.3 | Category: B | Product will feature an integrated “one-piece” machined 6061 aluminum base with perimeter |
| Crash Safety | | mounting tabs. The tabswill be a minimum of .225″ thick and accept a mounting screw such as |
| | | #10 machine screw. |
| Section 8 | Category: S | Product will use a machined 6061 aluminum base with machined internal bosses to fully secure |
| Vibration | (B3) | circuit card assemblies from vibration. All cable connections (internal & external) will be |
| | | positive locking. |
| Section 15 | Category: A | Product will be enclosed in an aluminum enclosure to mitigate any magnetic interference. |
| Magnetic Effect | | |
| Section 16.5 | Category: A | The main power input for the product will be 115 VAC, wide variable frequency (360 Hz to 800 Hz). |
| Electrical Power Input | (WF) | The input circuity will be designed in accordance with standard aerospace component standards. |
| Parameter Limits (AC) | | |
| Section 16.6 | Category: A | N/A |
| Eletrical Power Input | | |
| Parameter Limits (DC) | | |
| Section 16.7.1 | Category: A | The main power input for the product will be 115 VAC, wide variable frequency (360 Hz to 800 Hz). |
| Current Harmonic Emissions | (WF) | The input circuity will be designed in accordance with standard aerospace component standards. |
| Designation H (AC) | | |
| Section 36.7.5 | Category: A | The main power input for the product will be 115 VAC, wide variable frequency (360 Hz to 800 Hz). |
| Inrush Current | (WF) | The input circuity will be designed in accordance with standard aerospace component standards. |
| Designation I | | |
| Section 16.7.6 | Category: A | The main power input for the product will be 115 VAC, wide variable frequency (360 Hz to 800 Hz). |
| Current Modulation Design | (WF) | The input circuity will be designed in accordance with standard aerospace component standards. |
| L (AC) | | |
| Section 16.7.8 | Category: A | The main power input for the product will be 115 VAC, wide variable frequency (360 Hz to 800 Hz). |
| Power Factor Designation | (WF) | The input circuity will be designed in accordance with standard aerospace component standards. |
| P (AC) | | |
| Section 17 | Category: A | The product, in addition to standard electrical design properties, will withstand high and low |
| Voltage Spike | | voltage spikes, within a TBD limit. Other features such as capacitors or fuses will be used to |
| | | safeguard the product. |
| Section 18 | Category (AC): | The product will feature an eletrical circuit designed to accept standard frequencies harmonics |
| Audio Frequency Conducted | K (WF) | from a typical aircraft transformer rectification unit (main power source). |
| Susceptibility Power Input | | |
| Section 18 | Category (DC): | N/A |
| Audio Frequency Conducted | Z | |
| Sustantibility Power Input | | |
| Section 19 | Category: CW | The product will feature an electrical circuit designed to accept standard voltage harmonics |
| Induced Signal | | from a typical aircraft transformer rectification unit (main power source). |
| Susceptibilty | | |
| Section 21 | Catgeory: MH | The products circuit card assembly will be designed to mitigate EMI risk (the electrical circuit |
| Conducted & Emission | | design, components used and placement of components). Additionally, the aluminum enclosed will |
| of RF Energy | | feature overlapping top & bottom to minimize EMI. |
| Section 22 | Category: | The products main input circuit will have necessary suppressing components to withstand |
| Lightning Induced | BZ KZ LZ | high-voltage transient conditions. |
| Transient Susceptibility | | |
| Section 25 | Category: A | The product will be designed to mitigate ESD conditions, with design features such as enclosure |
| Electrostatic Discharge | | and dedicated Chassis pin grounding points and fully isolated internal circuit card assemblies. |
| FAR 25.853 | N/A | All materiais used will meet or exceed flammability requirements, such as the use of aluminum, |
| Flammability | | certified printed circuit boards, certified wire, etc. |

For example, the light distribution module 405 or light distribution module 406 can include a case 505 which can be an aluminum enclosure with aerospace grade internal components. The aluminum enclosure is configured to withstand −25 degree Celsius to 70 Celsius non-operating temperatures, and 5 Celsius to 55 Celsius operating temperatures. In certain embodiments, the system can intentionally not include materials that can be compressed or expanded in high or low pressure environments. Such materials can include, but are not limited to foam, tape, and plastics. The system can further mitigate susceptibility to humidity and magnetic interference, primarily through the mechanical enclosure design but also via coatings on the CCA's (such as conformal), gold connectors, etc. Furthermore, the light distribution module can comprise a one-piece machine aluminum base with perimeter mounting tabs. The tabs can be a minimum of 0.125 inches thick and accept mounting screws. The system can further include machined internal bosses to secure associated circuit cards from vibration. The associated cable connections can be positively locking connections. In certain embodiments, the power input can comprise a 115 VAC wide variable frequency (for example between 360 Hz-800 Hz). In other embodiments, the power input can comprise approximately 100 VAC with frequencies starting at 50 Hz. The system can be configured with an electrical design that can withstand high and low voltage spikes. The associated electrical circuitry can also be designed to accept standard frequency harmonics from an aircraft transformer rectification unit (e.g., a main power source).

Furthermore, the circuit card assemblies are designed to mitigate EMI, through the use of conventional multilayer printed circuit boards (PCB), high-voltage and high-susceptible signal trace routing and sub-component parts and placement locations within the CCA Likewise, the enclosure will feature an overlapping top and bottom to minimize EMI. The main input circuit can include suppressing components (such as super-capacitors to absorb electric energy) to withstand high-voltage transient conditions. The product can further mitigate ESD conditions. The enclosure and chassis pin ground points can be provided to fully isolate internal circuit card assemblies. Finally, all the materials used in the light distribution module can meet or exceed flammability requirements. The material can include aluminum, certified printed circuit boards, certified wires, etc.

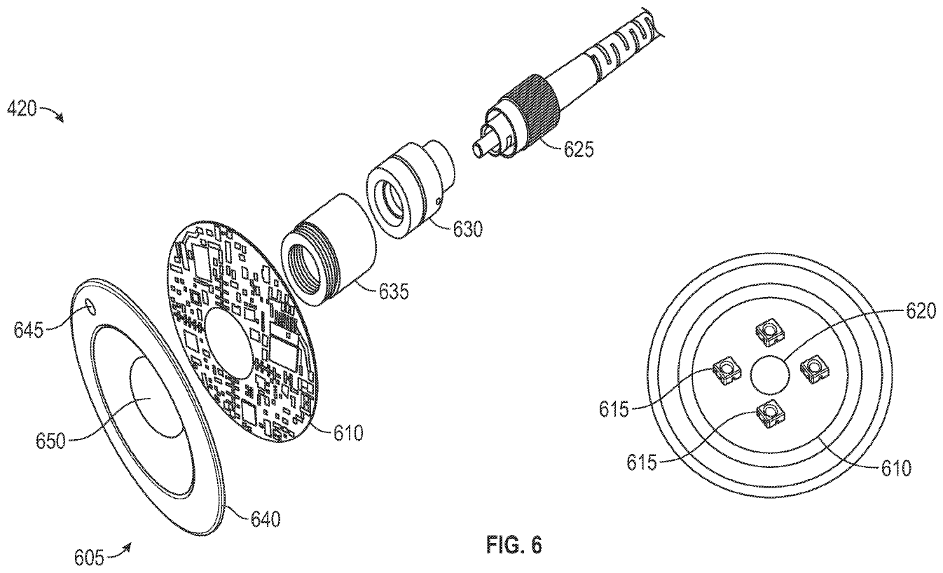

FIG. 6 illustrates an exemplary light adaptor fixture 420. The mechanical housing 605 can connect to a CCA 610 with LEDs 615, and a discrete input that is used as an auxiliary/emergency input. The main purpose of the CCA 610 is to provide a means of mounting the Fiber Light adaptor 620 to the mechanical housing 605. The CCA 610 also provides LEDs 615 that can be powered via an auxiliary/emergency input. In particular, the end of the transport fiber 625 can be connected to a collimator 630 and an adaptor 635 that fits with the CCA 610. That is, the adaptor 635 serves as the interface between the collimator 630 and CCA 610. The CCA 610 can comprise a custom built circuit that includes one or more emergency LEDs 615 with a dedicated input signal to activate. The light adaptor fixture 420 further includes a bezel 640 housing to which the CCA 610 can be mounted. The photocell diodes 645 may be mounted to the CCA 610 and visible either through the bezel 640, or through the lens 650 where light is emitted.

It should be appreciated that in various embodiments, the light adaptor fixture 420 can be fixed or directional. Aspects of the light adaptor fixture 420 can be selected to meet RTCA D0160 standards as illustrated in the tables in TABLE 2 for fixed embodiments and TABLE 3 directional embodiments.

TABLE 2

| RTCA/DO-160G | Sub-Category | Description: Laser Light Fiber Adaptor - Fixed |
|---|---|---|
| Section 4.5.1 | Category: A1 | Design shall be aluminum enclosure with aerospace grade internal components (circuit |
| Ground Survival Low | | card assemblies, cables, connectors) designed to withstand −25 C. (non-operating). |
| Temperature | | |
| Section 4.5.2 | Category: A1 | Design shall be aluminum enclosure with aerospace grade internal components (circuit |
| Operating Low | | card assemblies, cables, connectors) designed to withstand −5 C. (operating). |
| Temperature | | |
| Section 4.5.3 | Category: A1 | Design shall be aluminum enclosure with aerospace grade internal components (circuit |
| Ground Survival High | | card assemblies, cables, connectors) designed to withstand +70 C. (non-operating). |
| Temperature | | |
| Section 4.5.4 | Category: A1 | Design shall be aluminum enclosure with aerospace grade internal components (circuit |
| Operating High | & A2 | card assemblies, cables, connectors) designed to withstand +55 C. (operating). |
| Temperature | | |
| Section 4.6.1, 4.6.2, 4.6.3 | Category: A1 | Product will not utilize any material which can be compressed or expanded with pressure |
| Altitude, Decompression, | | (such as foam, tape, plastics, etc.). |
| Overpressure | | |
| Section 6 | Category: A | Product will use a aluminum enclosure, which is not affected by humidity conditions. |
| Humidity | | Internal circuit card assemblies and connections will use materials and assembly practices |
| | | to mitigate humidity susceptibility. |
| Section 7.2 | Category: B | Product will use mechanical design features, such as machined 6061 aluminum enclosure with |
| Operational Shock | | machined circuit card assembly & fiber cable mounting points and support bosses to eliminate |
| | | vibration or mechanical distortion. |
| Section 7.3.2 | Category: B | Product will feature an integrated “one-piece” machined 6061 aluminum base with perimeter |
| Crash Safety Shock | | mounting clamps/wings. Positive locking electrical and fiber connections will also be used. |
| Section 7.3.3 | Category: B | Product will feature an integrated “one-piece” machined 6061 aluminum base with perimeter |
| Crash Safety | | mounting clamps/wings. Positive locking electrical and fiber connections will also be used. |
| Section 8 | Category: S | Product will feature an integrated “one-piece” machined 6061 aluminum base with perimeter |
| Vibration | (B3) | mounting clamps/wings. Positive locking electrical and fiber connections will also be used. |
| Section 15 | Category: A | Product will be enclosed in an aluminum enclosure to mitigate any magnetic interference. |
| Magnetic Effect | | |
| Section 16.5 | Category: A | N/A |
| Electrical Power Input | (WF) | |
| Parameter Limits (AC) | | |
| Section 16.6 | Category: A | Electrical design will utilize standard aerospace power input design standards. |
| Eletrical Power Input | | |
| Parameter Limits (DC) | | |
| Section 16.7.1 | Category: A | N/A |
| Current Harmonic Emissions | (WF) | |
| Designation H (AC) | | |
| Section 36.7.5 | Category: A | While this unit is mostly just a passive device, it will feature 6 VDC and 28 VDC input power. |
| Inrush Current | (WF) | The input circuity will be designed in accordance with standard aerospace component standards. |
| Designation I | | |
| Section 16.7.6 | Category: A | N/A |
| Current Modulation Design | (WF) | |
| L (AC) | | |
| Section 16.7.8 | Category: A | N/A |
| Power Factor Designation | (WF) | |
| P (AC) | | |
| Section 17 | Category: A | While this unit is mostly just a pasive device, it will feature 6 VDC and 28 VDC input power. |
| Voltage Spike | | The input circuity will be designed in accordance with standard aerospace component standards |
| | | to account for typical voltage spikes during operation. |
| Section 18 | Category (AC): | N/A |
| Audio Frequency Conducted | K (WF) | |
| Susceptibility Power Input | | |
| Section 18 | Category (DC): | The product will feature an electrical circuit designed to accept standard frequencies harmonics |
| Audio Frequency Conducted | Z | from a typical aircraft transformer rectification unit (main power source). |
| Sustantibility Power Input | | |
| Section 19 | Category: CW | The product will feature in electrical circuit designed to accent standand frequencies harmonics |
| Induced Signal | | from a typical aircraft transformer rectification unit (main cower source). |
| Susceptibilty | | |
| Section 21 | Category: MH | The products circuit card assembly will be designed to mitigate EMI risk (the electrical circuit |
| Conducted & Emission | | design, components used and placement of components). Additionally, the aluminum encloser will |
| of RF Energy | | feature overlapping top & bottom to minimize EMI. |
| Section 22 | Category: BZ | The products main input circuit will have necessary suppressing components to withstand high-voltage |
| Lightning Induced | KZ LZ | transient conditions. |
| Transient Susceptibility | | |
| Section 25 | Category: A | The product will be designed to mitigate ESD conditions, with design features such as enclosure and |
| Electrostatic Discharge | | dedicated Chasis pin grounding points and fully isolated internal circuit card assemblies. |
| FAR 25.853 | N/A | All materials used will meet or exceed flammability requirements, such as the use of aluminum, |
| Flammability | | certified printed circuit boards, certified wire, etc. |

TABLE 3

| RTCA/DO-160G | Sub-Category | Description: Laser Light Fiber Adaptor - Directional |
|---|---|---|
| Section 4.5.1 | Category: A1 | Design shall be aluminum enclosure with aerospace grade internal components (circuit |
| Ground Survival Low | | card assemblies, cables, connectors) designed to withstand −25 C. (non-operating). |
| Temperature | | |
| Section 4.5.2 | Category: A1 | Design shall be aluminum enclosure with aerospace grade internal components (circuit |
| Operating Low | | card assemblies, cables, connectors) designed to withstand −5 C. (operating). |
| Temperature | | |
| Section 4.5.3 | Category: A1 | Design shall be aluminum enclosure with aerospace grade internal components (circuit |
| Ground Survival High | | card assemblies, cables, connectors) designed to withstand +70 C. (non-operating). |
| Temperature | | |
| Section 4.5.4 | Category: A1 | Design shall be aluminum enclosure with aerospace grade internal components (circuit |
| Operating High | & A2 | card assemblies, cables, connectors) designed to withstand +55 C. (operating). |
| Temperature | | |
| Section 4.6.1, 4.6.2, 4.6.3 | Category: A1 | Product will not utilize any material which can be compressed or expanded with pressure |
| Altitude, Decompression, | | (such as foam, tape, plastics, etc.). |
| Overpressure | | |
| Section 6 | Category: A | Product will use a aluminum enclosure, which is not affected by humidity conditions. |
| Humidity | | Internal circuit card assemblies and connections will use materials and assembly practices |
| | | to mitigate humidity susceptibility. |
| Section 7.2 | Category: B | Product will use mechanical design features, such as machined 6061 aluminum enclosure with |
| Operational Shock | | machined circuit card assembly & fiber cable mounting points and support bosses to eliminate |
| | | vibration or mechanical distortion. |
| Section 7.3.2 | Category: B | Product will feature an integrated “one-piece” machined 6061 aluminum base with perimeter |
| Crash Safety Shock | | mounting clamps/wings. Positive locking electrical and fiber connections will also be used. |
| Section 7.3.3 | Category: B | Product will feature an integrated “one-piece” machined 6061 aluminum base with perimeter |
| Crash Safety | | mounting clamps/wings. Positive locking electrical and fiber connections will also be used. |
| Section 8 | Category: S | Product will feature an integrated “one-piece” machined 6061 aluminum base with perimeter |
| Vibration | (B3) | mounting clamps/wings. Positive locking electrical and fiber connections will also be used. |
| Section 15 | Category: A | Product will be enclosed in an aluminum enclosure to mitigate any magnetic interference. |
| Magnetic Effect | | |
| Section 16.5 | Category: A | N/A |
| Electrical Power Input | (WF) | |
| Parameter Limits (AC) | | |
| Section 16.6 | Category: A | Electrical design will utilize standard aerospace power input design standards. |
| Eletrical Power Input | | |
| Parameter Limits (DC) | | |
| Section 16.7.1 | Category: A | N/A |
| Current Harmonic Emissions | (WF) | |
| Designation H (AC) | | |
| Section 36.7.5 | Category: A | While this unit is mostly just a passive device, it will feature 6 VDC and 28 VDC input power. |
| Inrush Current | (WF) | The input circuity will be designed in accordance with standard aerospace component standards. |
| Designation I | | |
| Section 16.7.6 | Category: A | N/A |
| Current Modulation Design | (WF) | |
| L (AC) | | |
| Section 16.7.8 | Category: A | N/A |
| Power Factor Designation | (WF) | |
| P (AC) | | |
| Section 17 | | |
| Voltage Spike | | |
| Section 18 | Category: A | While this unit is mostly just a pasive device, it will feature 6 VDC and 28 VDC input power. |
| Audio Frequency Conducted | | The input circuity will be designed in accordance with standard aerospace component standards |
| Susceptibility Power Input | | to account for typical voltage spikes during operation. |
| Section 18 | Category (AC): | N/A |
| Audio Frequency Conducted | K (WF) | |
| Sustantibility Power Input | | |
| Section 19 | Category (DC): | The product will feature an electrical circuit designed to accept standard frequencies harmonics |
| Induced Signal | Z | from a typical aircraft transformer rectification unit (main power source). |
| Susceptibilty | | |
| Section 21 | Category: CW | The product will feature in electrical circuit designed to accent standand frequencies harmonics |
| Conducted & Emission | | from a typical aircraft transformer rectification unit (main cower source). |
| of RF Energy | | |
| Section 22 | Category: MH | The products circuit card assembly will be designed to mitigate EMI risk (the electrical circuit |
| Lightning Induced | | design, components used and placement of components). Additionally, the aluminum encloser will |
| Transient Susceptibility | | feature overlapping top & bottom to minimize EMI. |
| Section 25 | Category: BZ | The products main input circuit will have necessary suppressing components to withstand high-voltage |
| Electrostatic Discharge | KZ LZ | transient conditions. |
| FAR 25.853 | Category: A | The product will be designed to mitigate ESD conditions, with design features such as enclosure and |
| Flammability | | dedicated Chasis pin grounding points and fully isolated internal circuit card assemblies. |
| FAR 25.853 | N/A | All materials used will meet or exceed flammability requirements, such as the use of aluminum, |
| Flammability | | certifiedprinted circuit boards, certified wire, etc. |

For example, the light adaptor fixture can include a housing which can comprise an aluminum enclosure with aerospace grade internal components, designed to withstand −25 Celsius to 70 Celsius nonoperating temperatures and −5 Celsius to 55 Celsius operating temperatures. In certain embodiments, the system can intentionally not include materials that can be compressed or expanded in high or low pressure environments. Such materials can include, but are not limited to foam, tape, and plastics. The system can further mitigate susceptibility to humidity and magnetic interference. Furthermore, the light adaptor fixture can comprise a machined 6061 aluminum enclosure with a machined circuit card assembly and fiber cable mounting points and support bosses to eliminate vibration and mechanical distortion. The enclosure can further include an aluminum base with perimeter mounting clamps/wings and can incorporate positive locking electrical and fiber connections. The design of electrical components can utilize standard aerospace power input design standards.

While the light adaptor fixture is generally a passive device, in certain embodiments, the light adaptor fixture can include a discrete 6 VDC (5 VDC-7 VDC) and 28 VDC (18VDC32 VDC) power input. The input circuitry is configured to meet aerospace component standards to account for typical voltage spikes during operation. The electrical circuit is further designed to accept standard frequency harmonics from a typical aircraft transformer rectification unit (i.e., a main power source). The light adaptor fixture is further designed to mitigate EMI risk. The aluminum enclosure will feature an overlapping top & bottom to minimize EMI. The input circuits can include suppressing components to withstand high voltage transient conditions. The light adaptor fixture can be further designed to mitigate ESD conditions. Such design features include an enclosure and dedicated chassis pin ground point and fully isolated internal circuit card assembly. Finally, all the materials used in the light adaptor fixture can meet or exceed flammability requirements. The material can include aluminum, certified printed circuit boards, certified wires, etc.

The emissive fiber 555 can be connected to an output which can provide a lighting wash effect along with LiFi connectivity and sanitization. Emissive fiber has additional advantages by not generating or radiating heat, noise and being light weight and pliable so that it can be routed to various locations in the cabin of an aircraft, or other such environment.

The emissive fiber 555 can be configured to meet various RTCA DO-160 emissive fiber requirements. An outline of such requirements and associated design aspects are outlined in the Table 4. The emissive fiber cable can be certified to operate in conditions which exceed RTCA DO-160 requirements such that the operating temperatures can be between −65 Celsius and +135 Celsius. In addition, the emissive fiber can meet FAR 25.853 flammability by including an outer cable jacket material comprising, for example, perfluoro alkoxy (PFA).

TABLE 4

| RTCA/DO-160G | Sub-Category | Description: Emissive Fiber Cable |
|---|---|---|
| Section 4.5.1 | Category: A1 | N/A |
| Ground Survival Low | | |
| Temperature | | |
| Section 4.5.2 | Category: A1 | The fiber cable sourced will be certified to operate in conditions which exceed |
| Operating Low | | DO-160 requirements. Expected operating low shall be −65C. |
| Temperature | | |
| Section 4.5.3 | Category: A1 | N/A |
| Ground Survival High | | |
| Temperature | | |
| Section 4.5.4 | Category: A1 | The fiber cable sourced will be certified to operate in conditions which exceed |
| Operating High | & A2 | DO-160 requirements. Expected operating high shall be +135 C. |
| Temperature | | |
| Section 4.6.1, 4.6.2, 4.6.3 | Category: A1 | N/A |
| Altitude, Decompression, | | |
| Overpressure | | |
| Section 6 | Category: A | N/A |
| Humidity | | |
| Section 7.2 | Category: B | N/A |
| Operational Shock | | |
| Section 7.3.2 | Category: B | N/A |
| Crash Safety Shock | | |
| Section 7.3.3 | Category: B | N/A |
| Crash Safety | | |
| Section 8 | Category: S | N/A |
| Vibration | (B3) | |
| Section 15 | Category: A | N/A |
| Magnetic Effect | | |
| Section 16.5 | Category: A | N/A |
| Electrical Power Input | (WF) | |
| Parameter Limits (AC) | | |
| Section 16.6 | Category: A | N/A |
| Eletrical Power Input | | |
| Parameter Limits (DC) | | |
| Section 16.7.1 | Category: A | N/A |
| Current Harmonic Emissions | (WF) | |
| Designation H (AC) | | |
| Section 36.7.5 | Category: A | N/A |
| Inrush Current | (WF) | |
| Designation I | | |
| Section 16.7.6 | Category: A | N/A |
| Current Modulation Design | (WF) | |
| L (AC) | | |
| Section 16.7.8 | Category: A | N/A |
| Power Factor Designation | (WF) | |
| P (AC) | | |
| Section 17 | Category: A | N/A |
| Voltage Spike | | |
| Section 18 | Category (AC): | N/A |
| Audio Frequency Conducted | K (WF) | |
| Susceptibility Power Input | | |
| Section 18 | Category (DC): | N/A |
| Audio Frequency Conducted | Z | |
| Sustantibility Power Input | | |
| Section 19 | Category: CW | N/A |
| Induced Signal | | |
| Susceptibilty | | |
| Section 21 | Category: MH | N/A |
| Conducted & Emission | | |
| of RF Energy | | |
| Section 22 | Category: BZ | N/A |
| Lightning Induced | KZ LZ | |
| Transient Susceptibility | | |
| Section 25 | Category: A | N/A |
| Electrostatic Discharge | | |
| FAR 25.853 | N/A | This sourced fiber cable will meet FAR 25.853 by using an outer cable jacket |
| Flammability | | material such as perfluoroalkoxy (PFA). |

The transport fiber can similarly be configured to meet various RTCA DO-160 cable requirements. An outline of such requirements and associated design aspects are outlined in the Table 5. The transport fiber cable can be certified to operate in conditions which exceed RTCA DO-160 requirements such that the operating temperatures can be between −65 Celsius and +135 Celsius. In addition, the emissive fiber can meet FAR 25.853 flammability by including an outer cable jacket material comprising, for example, perfluoro alkoxy (PFA).

TABLE 5

| RTCA/DO-160G | Sub-Category | Description: Transport Fiber Cable |
|---|---|---|
| Section 4.5.1 | Category: A1 | N/A |
| Ground Survival Low | | |
| Temperature | | |
| Section 4.5.2 | Category: A1 | The fiber cable sourced will be certified to operate in conditions which exceed |
| Operating Low | | DO-160 requirements. Expected operating low shall be −65 C. |
| Temperature | | |
| Section 4.5.3 | Category: A1 | N/A |
| Ground Survival High | | |
| Temperature | | |
| Section 4.5.4 | Category: A1 | The fiber cable sourced will be certified to operate in conditions which exceed |
| Operating High | & A2 | DO-160 requirements. Expected operating high shall be +135 C. |
| Temperature | | |
| Section 4.6.1, 4.6.2, 4.6.3 | Category: A1 | N/A |
| Altitude, Decompression, | | |
| Overpressure | | |
| Section 6 | Category: A | N/A |
| Humidity | | |
| Section 7.2 | Category: B | N/A |
| Operational Shock | | |
| Section 7.3.2 | Category: B | N/A |
| Crash Safety Shock | | |
| Section 7.3.3 | Category: B | N/A |
| Crash Safety | | |
| Section 8 | Category: S | N/A |
| Vibration | (B3) | |
| Section 15 | Category: A | N/A |
| Magnetic Effect | | |
| Section 16.5 | Category: A | N/A |
| Electrical Power Input | (WF) | |
| Parameter Limits (AC) | | |
| Section 16.6 | Category: A | N/A |
| Eletrical Power Input | | |
| Parameter Limits (DC) | | |
| Section 16.7.1 | Category: A | N/A |
| Current Harmonic Emissions | (WF) | |
| Designation H (AC) | | |
| Section 36.7.5 | Category: A | N/A |
| Inrush Current | (WF) | |
| Designation I | | |
| Section 16.7.6 | Category: A | N/A |
| Current Modulation Design | (WF) | |
| L (AC) | | |
| Section 16.7.8 | Category: A | N/A |
| Power Factor Designation | (WF) | |
| P (AC) | | |
| Section 17 | Category: A | N/A |
| Voltage Spike | | |
| Section 18 | Category (AC): | N/A |
| Audio Frequency Conducted | K (WF) | |
| Susceptibility Power Input | | |
| Section 18 | Category (DC): | N/A |
| Audio Frequency Conducted | Z | |
| Sustantibility Power Input | | |
| Section 19 | Category: CW | N/A |
| Induced Signal | | |
| Susceptibilty | | |
| Section 21 | Category: MH | N/A |
| Conducted & Emission | | |
| of RF Energy | | |
| Section 22 | Category: BZ | N/A |
| Lightning Induced | KZ LZ | |
| Transient Susceptibility | | |
| Section 25 | Category: A | N/A |
| Electrostatic Discharge | | |
| FAR 25.853 | N/A | The sourced fiber cable will meet FAR 25.853 by using an outer cable jacket |
| Flammability | | material such as perfluoroalkoxy (PFA). |

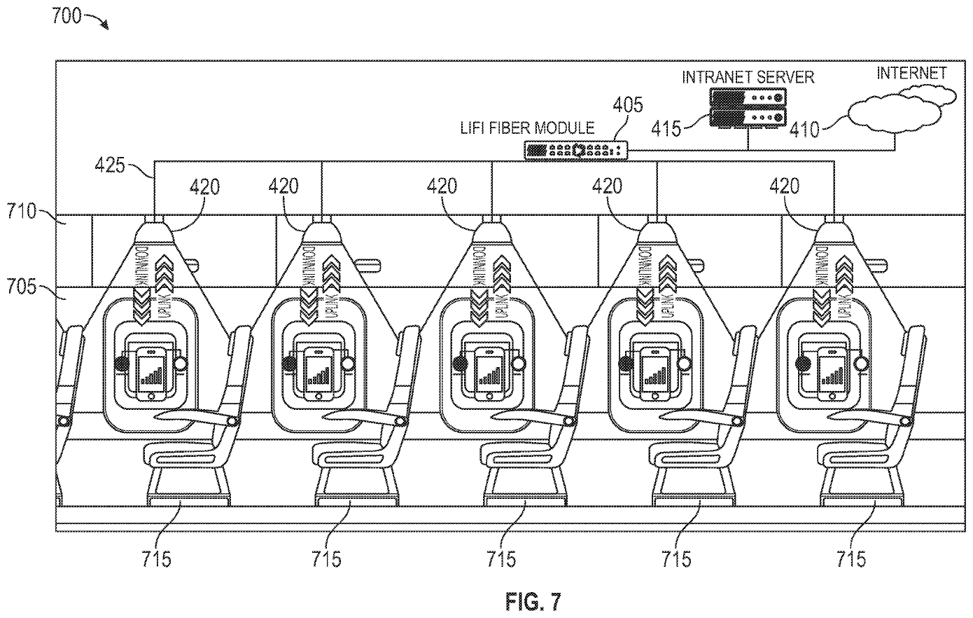

FIG. 7 illustrates an exemplary architecture 700 of the systems disclosed herein. In such an embodiment, the light distribution module 405 can be connected to an intranet server 415 and the internet 410. A series of one or more fiber distribution lines 425 can be used to connect a series of light adaptor fixtures 420 to the light distribution module 405 or light distribution module 406. It should be appreciated that, in the embodiments disclosed herein, light distribution module 405 is illustrated for exemplary purposes but all the disclosed embodiments can also be configured with respect to light distribution module 406. The light adaptor fixtures 420 can be distributed throughout, for example, the cabin 705 of an aircraft 710. In certain embodiments, the light adaptor fixtures 420 can each be placed so as to provide light to each bank of seats 715 as shown in FIG. 7.

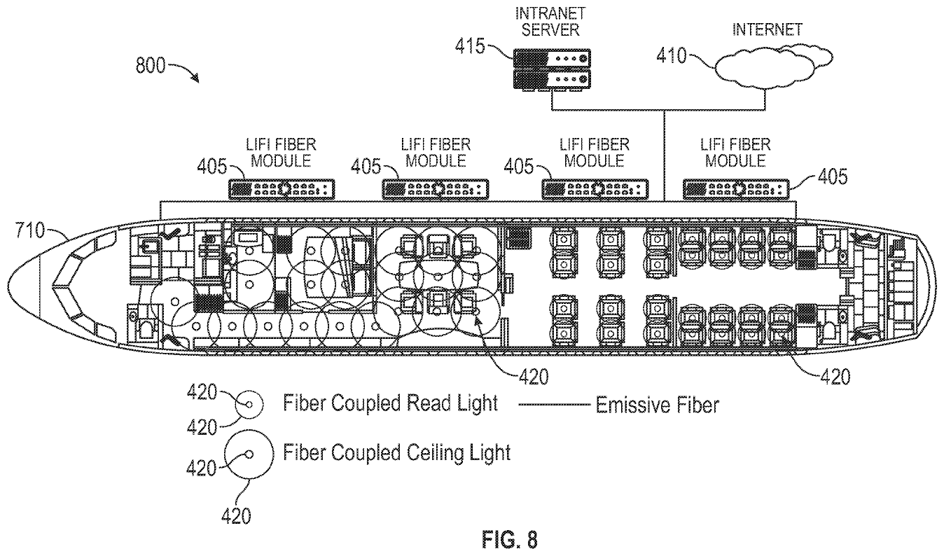

FIG. 8 further illustrates system architecture 800 in an exemplary case where the system is used in an aircraft 710. As illustrated, multiple light distribution modules 405 or light distribution module 406 can be dispersed in an aircraft 710. Light adaptor fixtures 420 can be connected to proximate light distribution modules 405 or light distribution module 406 in various areas of the aircraft 710 to provide ambient light, a data communication network, and sterilization.

In certain embodiments, additional photocells, separate from the light housing, can be distributed throughout the aircraft cabin, or other such environment. The high speed photocell can be used in place of, or in conjunction with, other photo detector and transmitter elements in the system. The highspeed photocells can be distributed to ensure adequate data network coverage and prevent dead spots.

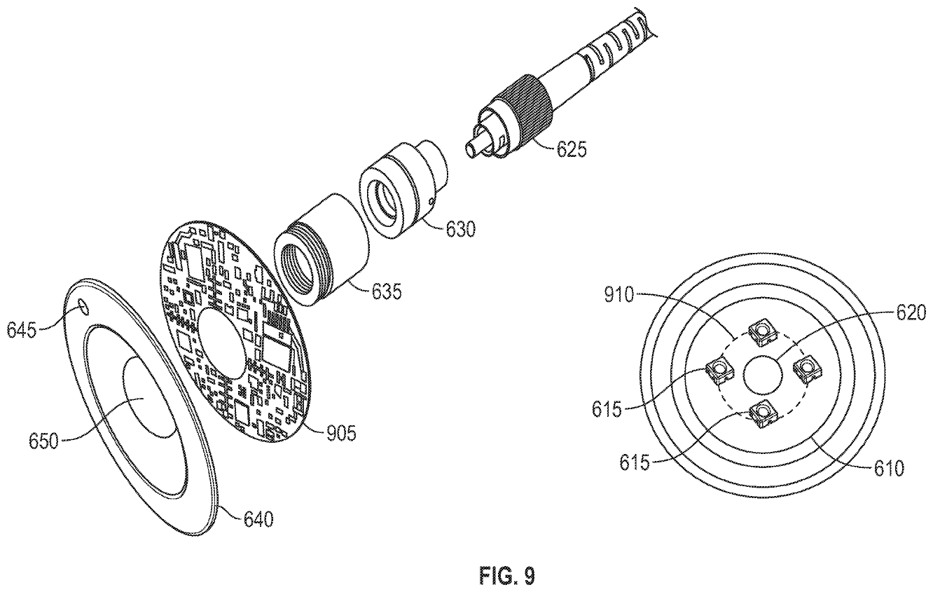

FIG. 9 illustrates aspects of another embodiment of the light adaptor fixture 420. In such an embodiment, the CCA 905 can incorporate a UVC LED 910. It should be noted that in such embodiments, FAR-UVC LEDs can be in incorporated in the mechanical housing, as opposed to sanitization lights being incorporated directly in the LiFi module itself. The use of UV LED's, and non-LED emitter technologies may emit the entire UV spectrum of wavelengths (100 nm-405 nm). In certain embodiments, Nano LED emitter technology can also be used.

In various embodiments, control systems can be used to control the activation of FAR-UVC emitters or other sanitization functionality. Specifically, the system can be deactivated periodically, in the presence of humans, or can be left on continuously. Various design considerations may dictate the operational parameters of the sanitization system. Activation of the sanitization function can be accomplished via a discrete voltage input (6 VDC-28 VDC) to the light distribution module.

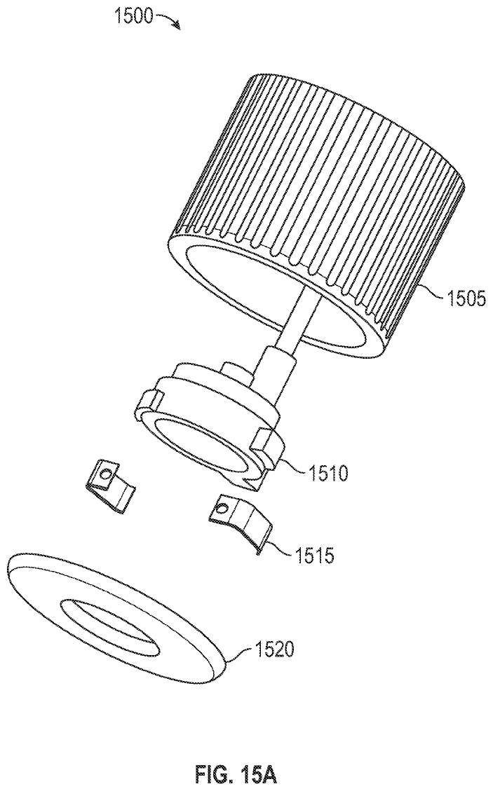

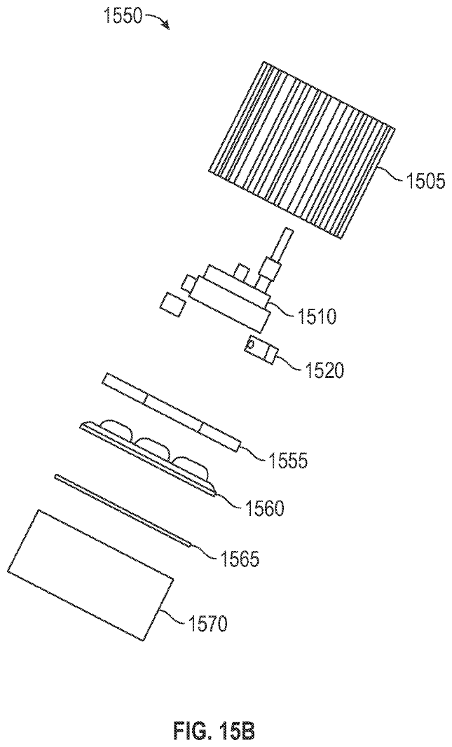

Aspects of embodiments incorporating FAR-UVC emitters are further detailed in FIGS. 15A and 15B. Generally speaking, FAR-UVC technology emits broad band UVC and uses filters to try and limit the “bad” wavelengths from being emitted. The disclosed embodiments make use of a Nano LED technology. Nano LED technology is advantageous in the current system because it is small and capable enough to be effective. In the disclosed embodiments the Nano LED can comprise many LEDs in a very small space emitting FAR-UVC light. The configuration does not require filters, because it only generates the necessary wavelengths.

FIG. 15A illustrates a first embodiment of a FAR-UVC assembly 1500. The assembly 1500 includes a housing 1505 with a UVC emitter 1510, which can include, for example, a FAR-UVC emitter therein. A bracket 1515 connects the FAR-UVC emitter 1510 to a bezel 1520 which mounts to the housing 1505. FIG. 15B illustrates another embodiment of a FAR-UVC assembly 1550. In this embodiment, the assembly 1550 includes a CCA 1555 adapted to interface with a fitting 1560. The fitting 1560 can comprise, for example, six mini parabolic round concave reflective surfaces, in the optical path of lens 1565. An outer ring 1570 can be used to mount the fitting 1560 and lens 1565 to the housing 1505.

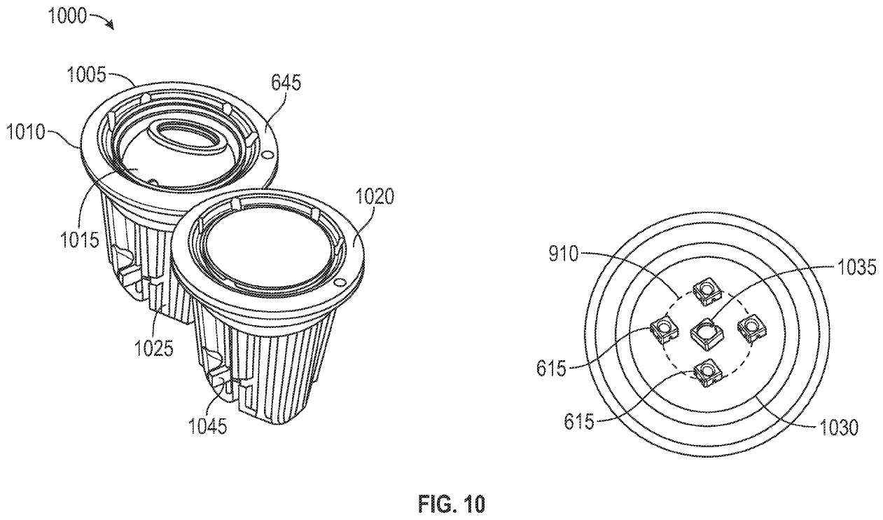

FIG. 10 illustrates features of a modular LiFi sanitization system 1000 wherein various architectural components, as detailed in other embodiments, are incorporated into a single unit 1005. In such embodiments, a housing 1010 can include a fixture 1015 where all the electronics in the CCA 1030 are built into the unit itself. In such an embodiment, lights can be connected to a network via a 10 GB PoE connection. Various mechanical configurations are possible including a mounting flipper 1045 to sandwich installation panel, and can be designed as drop-in replacements to common light types to simplify installation.

The single unit can have an operating voltage between 22 VDC and 32 VDC, and can have a primarily or completely aluminum design. The design can further incorporate a magnetic decorative bezel 1020. The auxiliary/emergency discrete input 1025 can be 6 VDC (or other required voltage). The unit can be LiFi enabled and can include an ultra-bright laser SMD 1035 with infrared capability for lighting and connectivity, and a FAR-UVC emitter 910 for sanitization. The system 1000 can further include LEDs 615 that can be powered via an auxiliary/emergency input. The system 1000 can include connections for power over ethernet which provides the ability for multiple such units to be daisy chained together.

In certain embodiments the system can be configured to provide sanitization only capability in a standalone housing as illustrated in FIGS. 15A, which does not require any light distribution module at all, only sanitization with a 6 VDC-28 VDC power input. Similarly in another embodiment sanitization capability can be provided with lighting in a standalone housing as illustrated in FIG. 15B which could be LED or Laser SMD. Such an embodiment, but would also not require a light distribution module and can have a 6 VDC-28 VDC power input.

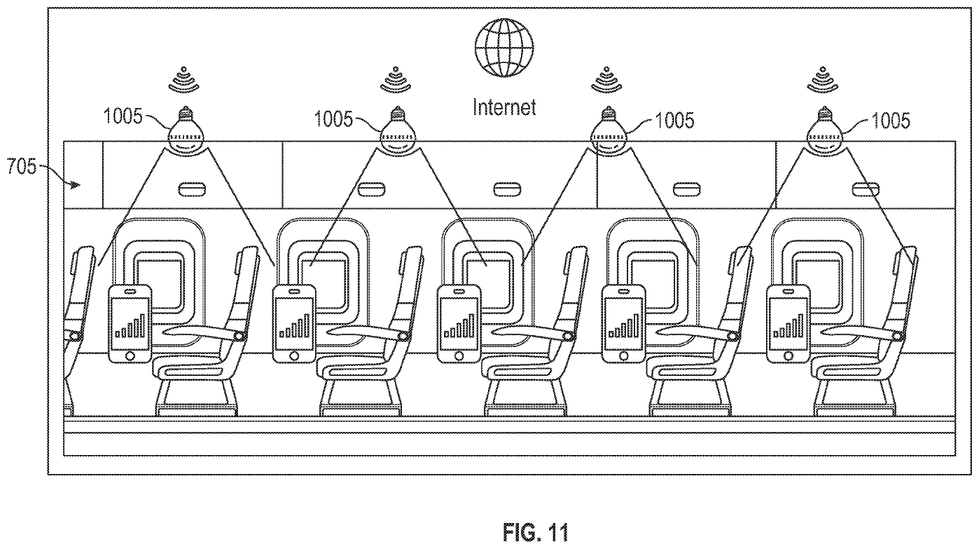

FIG. 11, depicts a higher level system 1100 diagram showing the overall system architecture for the single unit embodiments illustrated in FIG. 10. In this architecture, the intranet server on the aircraft (or other environment) can be connected to a PoE switch which can be connected to unit 1005, routing bi-directional network data, and power to the lights. This provides cabin 705 lighting, as well as ultra-high speed connectivity and air and/or surface sanitization.

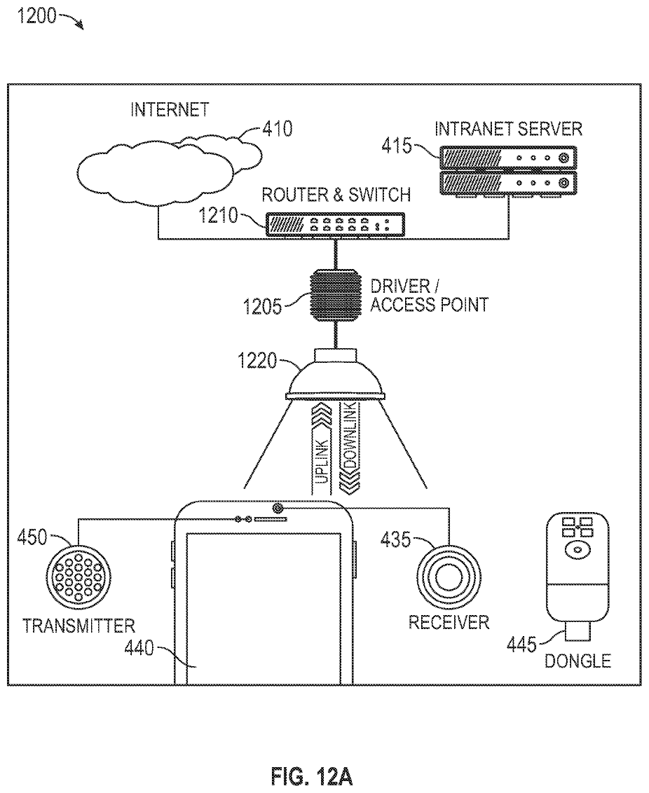

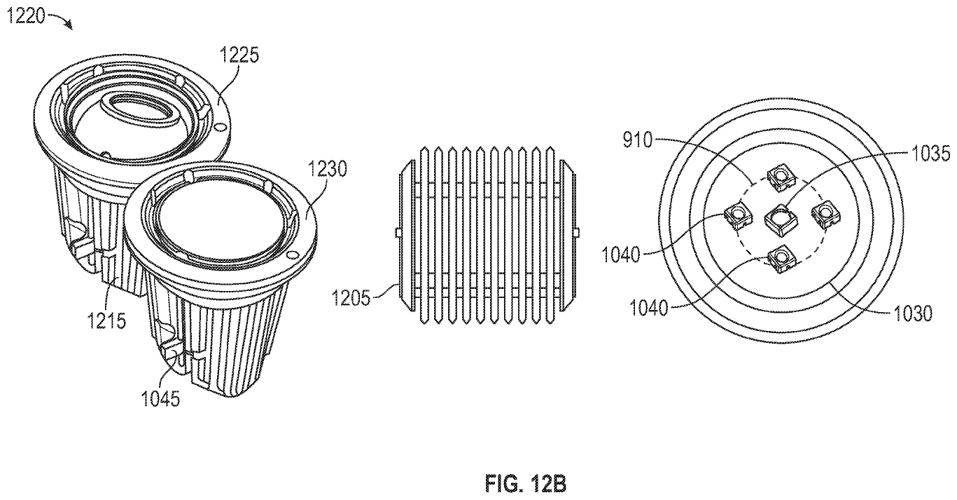

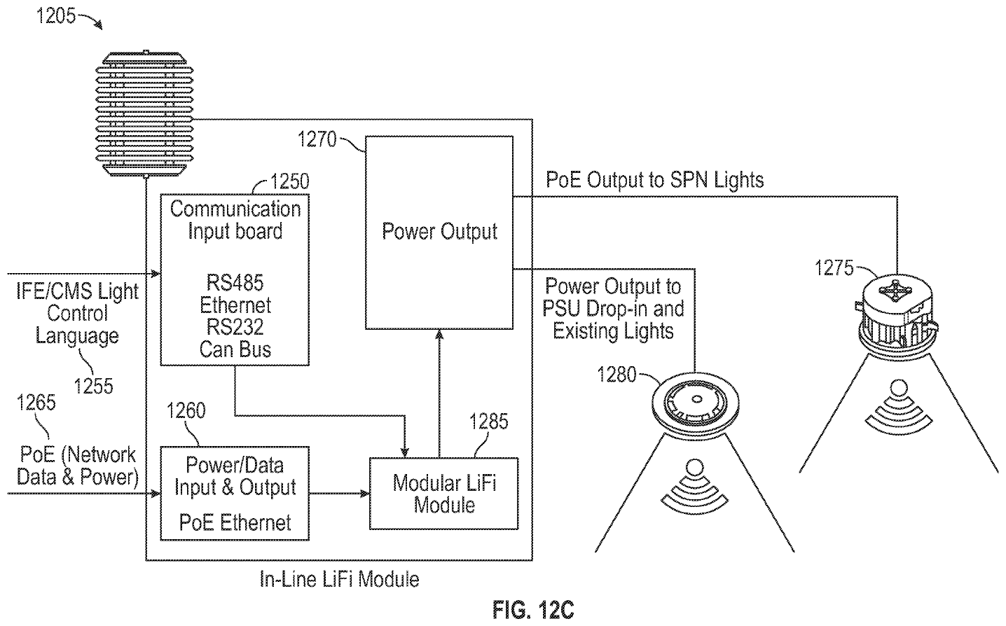

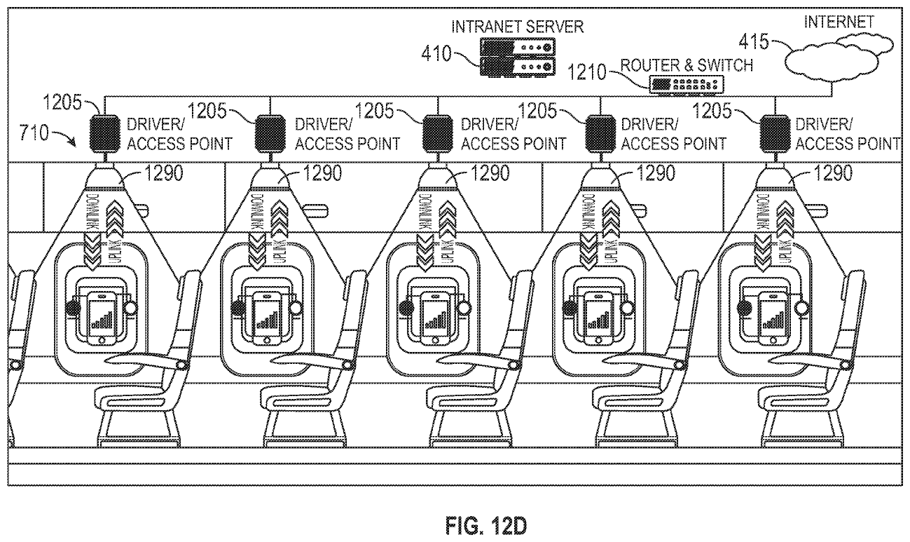

In another embodiment, certain aspects of the system can be configured with an inline driver/access point module 1205. FIG. 12A, illustrates system 1200 architecture incorporating the inline driver/access point module 1205. As illustrated, the internet connection 410 and intranet server 415 for the aircraft, or other such environment, can be connected to the in-line driver/access point module 1205. As in other embodiments, the system 1200 uses, for example, a 10 GB PoE backbone and connects in between the router/switch 1210 and the light adaptor module 1220. The advantage of the embodiments, illustrated in FIG. 12A, is that the in-line driver/access point module is modular and therefore affords the ability to upgrade the in-line unit as technology and speeds evolve, as opposed to having to replace the entire lighting system. It should be noted an advantage of the disclosed embodiments is that it provides a means to give LiFi access to existing LED lighting systems.

The electronics in this embodiment can be substantially identical to those in other embodiments, except that the LiFi components are housed in the in-line driver/access point module 1205. Likewise, the lights 1220 in this variant carry all the same characteristics as other disclosed embodiment, except the LiFi electronics are removed from the light and contained in the “in-line” driver/access module 1205.

For example, as shown in FIG. 12B, the lighting fixtures can include a discrete input 1215 (e.g., 6 VDC auxiliary/emergency input) on the housing 1220, with a photo detector 1225 arranged on the magnetic bezel 1230. The in-line driver/access point 1205 can be down line and can include LiFi electronics.

FIG. 12C provides an exemplary diagram of the in-line driver/access point module 1205 in accordance with the disclosed embodiments. The module 1205 can be configured with a communication input board 1250 which can accept an IFC/CMS light control language 1255. The module 1205 can further include power/data input and output 1260 via a POE RJ45 jack 1265. The communication input board 1250 and PoE input and output 1265 can be operably connected to a LiFi module 1285, which is connected to a power output 1270 that serves a POE output to spectrum network lights 1275 and/or passenger service drop in lights 1280, or existing lights.

An exemplary architecture in an aircraft 710 (or other such environment) using a series of in-line driver/access point modules 1205, is illustrated in FIG. 12D. As shown, a sperate in-line driver/access point module 1205 can optionally be configured for each light fixture 1290 in the aircraft. This modular architecture allows one or more of the in-line driver/access point modules 1205 to be replaced for service or upgraded as new technology is developed. Such embodiments are also useful because their modular nature means if one module fails, the other modules remain operational for the remainder of the aircraft.

In certain embodiments, one or more additional sensors can be installed adjacent to certain cabin components (e.g., touchscreens or displays) to create a wirelessly connected cabin. For example, a display that is part of a Cabin Management System (CMS)/In-Flight Entertainment (IFE) System generally requires power, communication, source, and ethernet wiring. In the disclosed embodiments, a sensor package incorporating LiFi componentry can be provided as a dongle or other such peripheral device.

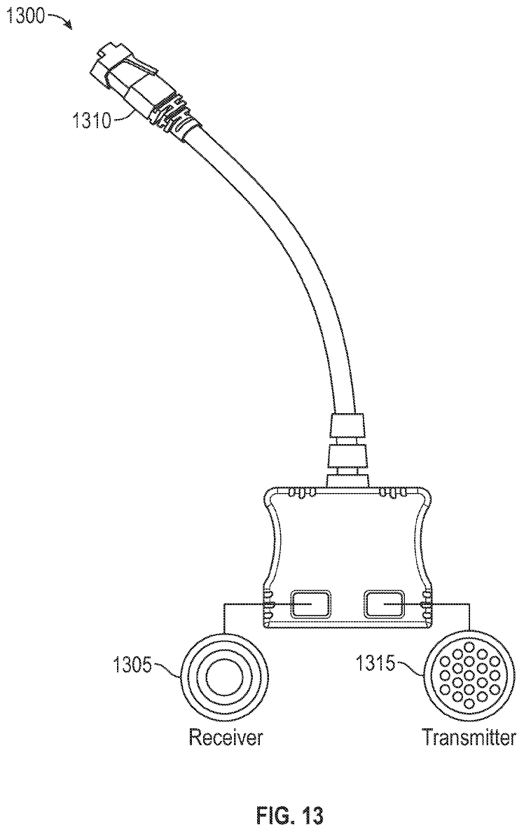

One such device is illustrated in FIG. 13. The dongle 1300 can include a photosensor 1305 that can receive light data and covert that data into content which it can route into another device's (touchscreen or display) input. This connection may be accomplished via ethernet connection 1310 (as shown), USB, and/or USB-C. The dongle 1300 can further include a transmitter 1315. This allows operators the ability to only wire power to the touchscreens and/or displays with all other data service handled wirelessly via the disclosed LiFi system and dongle. This configuration dramatically reduces aircraft wiring, weight, and complexity.

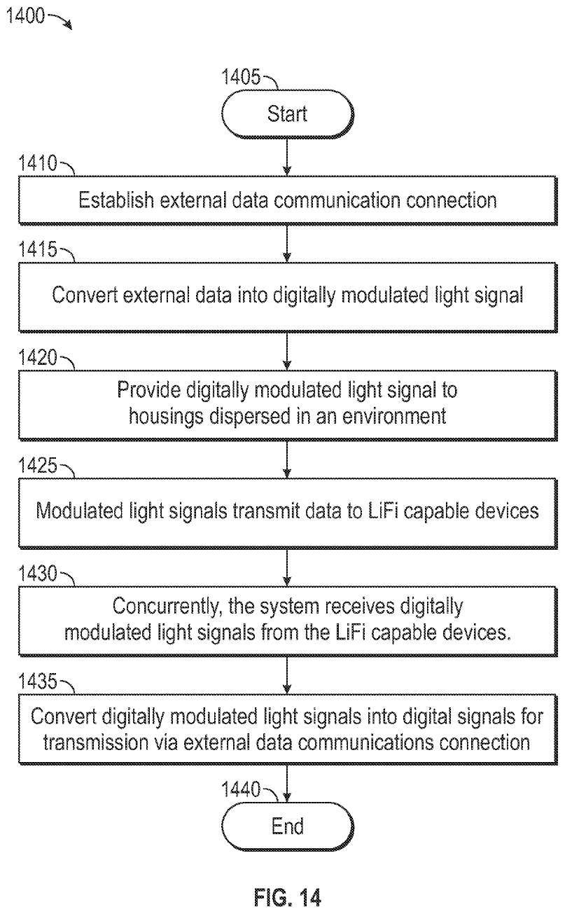

FIG. 14 illustrates a flow chart of steps associated with a method 1400 for providing internet connectivity in an environment such as an aircraft. The method starts at 1405.

Initially at step 1410, an external data communication connection can be established via a satellite connection, cellular network, terrestrial internet connection point, or the like. The data served from the external data communication connection can then be converted into a modulated light signal at step 1415. In certain embodiments, the modulated light signal can then be distributed as laser light via fiber optic cable, to one or more fixtures distributed in the environment at step 1420.

At step 1425 the modulated light signals transmit the external data to LiFi enabled devices in the environment. The fixtures can further be configured to provide ambient cabin lighting and/or sanitization via FAR-UVC (222 nm) and/or 405 nm light which can neutralize viruses and pathogens in the environment.

Concurrently at step 1430, LiFi enabled devices in the environment can transmit modulated light signals which can be captured by light sensors associated with the fixtures. The modulated light signals can be converted into digital signals which can be transmitted via the external data communication connection at step 1435. The method ends at 1440.

Accordingly, the disclosed embodiments take advantage of LiFi technology, and the use of laser light, to provide a much higher data throughput capability than existing LED based technology. The disclosed systems and methods further provide air and surface sanitization. The system can provide basic white light via Laser SMDs or Red Green Blue (RGB) variations. Furthermore, the disclosed embodiments are unique in that the light source (Laser SMDs) are located remotely in a central distribution box. Transport fiber lines can be routed therefrom to various mechanical light enclosures. This architecture removes the need for power lines being routed to each and every light on the aircraft, dramatically reducing aircraft weight, cabin heat, and noise.

Based on the foregoing, it can be appreciated that a number of embodiments, preferred and alternative, are disclosed herein. For example, in an embodiment, a system comprises a light distribution module, at least one light adaptor fixture, and at least one fiber distribution line connecting the light distribution module and the at least one fiber adaptor fixture.

In an embodiment, the light distribution module further comprises a communication input board, a data processing module, a LiFi photocell input, and a LiFi and sanitation output module.

In an embodiment, the at least one fiber distribution line further comprises at least one of a transport fiber and at least one wash light emissive fiber.

In an embodiment, the at least one fiber adaptor fixture further comprises a circuit card assembly and an aluminum mechanical enclosure with an electromagnetic interference lip. In an embodiment, the at least one fiber adaptor fixture further comprises a collimator attached to the at least one fiber distribution line, an adaptor coupled to the circuit card assembly with at least one light emitting diode. In an embodiment, the aluminum mechanical enclosure is configured to withstand −25 degree Celsius to 70 Celsius non-operating temperatures, and 5 Celsius to 55 Celsius operating temperatures. In an embodiment, the fiber adaptor fixture further comprises a photo detector on the housing. In an embodiment, the at least one light emitting diode comprise at least one of a Far-UVC Emitter, a Nano LED, and an infrared light.

In an embodiment, the light distribution module, at least one light adaptor fixture, and at least one fiber distribution line are configured to self-extinguish within a specified time. In an embodiment, the system includes at least one photocell.

In an embodiment, the system further comprises a server operably connected to the light distribution module.

In an embodiment, a system for data communication comprises a light distribution module, at least one light adaptor fixture configured in the cabin of an aircraft, at least one fiber distribution line connecting the light distribution module and the at least one fiber adaptor fixture, a server operably connected to the light distribution module, at least one transport fiber, and at least one wash light emissive fiber.

In an embodiment of the system for data communication, the light distribution module further comprises a communication input board, a data processing module, a LiFi photocell input, and a LiFi and sanitation output module.

In an embodiment of the system for data communication, the at least one fiber adaptor fixture further comprises a circuit card assembly, a collimator attached to the at least one fiber distribution line, an adaptor coupled to the circuit card assembly, at least one light emitting diode, and an aluminum mechanical enclosure with an electromagnetic interference lip housing the circuit card assembly, the collimator, and the adaptor.

In an embodiment of the system for data communication, the at least one light emitting diode comprise at least one of a Far-UVC Emitter and a Nano LED.

In an embodiment, a data communication system for providing light in an enclosed environment comprises a light distribution module comprising a communication input board, a data processing module, a LiFi photocell input, and a LiFi and sanitation output module; at least one light adaptor fixture further comprising a circuit card assembly, a collimator attached to the at least one fiber distribution line, an adaptor coupled to the circuit card assembly, at least one light emitting diode, and a housing for the circuit card assembly, the collimator, the adaptor, and the light emitting diode; and at least one fiber distribution line connecting the light distribution module and the at least one fiber adaptor fixture. In an embodiment, the at least one fiber distribution line further comprises a transport fiber. In an embodiment, the system further comprises at least one wash light emissive fiber. In an embodiment, the housing further comprises an aluminum mechanical enclosure with an electromagnetic interference lip and a photo detector on the housing. In an embodiment, the enclosed environment comprises the cabin of an aircraft.

It should be appreciated that variations of the above-disclosed and other features and functions, or alternatives thereof, may be desirably combined into many other different systems or applications. It should be understood that various presently unforeseen or unanticipated alternatives, modifications, variations or improvements therein may be subsequently made by those skilled in the art which are also intended to be encompassed by the following claims.

What is claimed is:

1. A system comprising:
a light distribution module;
at least one light adaptor fixture; and
at least one fiber distribution line connecting the light distribution module and the at least one fiber adaptor fixture.

2. The system of claim 1 wherein the light distribution module further comprises:
a communication input board;
a data processing module;
a LiFi photocell input; and
a LiFi and sanitation output module.

3. The system of claim 1 wherein the at least one fiber distribution line further comprises at least one of:
a transport fiber; and
at least one wash light emissive fiber.

4. The system of claim 1 wherein the at least one fiber adaptor fixture further comprises:
a circuit card assembly; and
an aluminum mechanical enclosure with an electromagnetic interference lip.

5. The system of claim 4 wherein the at least one fiber adaptor fixture further comprises:
a collimator attached to the at least one fiber distribution line; and
an adaptor coupled to the circuit card assembly with at least one light emitting diode.

6. The system of claim 5 wherein the aluminum mechanical enclosure is configured to withstand −25 degree Celsius to 70 Celsius non-operating temperatures, and 5 Celsius to 55 Celsius operating temperatures.

7. The system of claim 5 further comprising:
a photo detector on the housing.

8. The system of 5 wherein the at least one light emitting diode comprise at least one of:
a Far-UVC Emitter;
a Nano LED; and
an infrared light.

9. The system of 5 wherein the light distribution module, at least one light adaptor fixture, and at least one fiber distribution line are configured to self-extinguish within a specified time.

10. The system of claim 1 further comprising:
at least one photocell.

11. The system of claim 1 further comprising:
a server operably connected to the light distribution module.

12. A system for data communication comprising:
a light distribution module;
at least one light adaptor fixture configured in the cabin of an aircraft;
at least one fiber distribution line connecting the light distribution module and the at least one fiber adaptor fixture;
a server operably connected to the light distribution module;
at least one transport fiber; and
at least one wash light emissive fiber.

13. The system of claim 12 wherein the light distribution module further comprises:
a communication input board;
a data processing module;
a LiFi photocell input; and
a LiFi and sanitation output module.

14. The system of claim 12 wherein the at least one fiber adaptor fixture further comprises:
a circuit card assembly;
a collimator attached to the at least one fiber distribution line;
an adaptor coupled to the circuit card assembly;
at least one light emitting diode; and
an aluminum mechanical enclosure with an electromagnetic interference lip housing the circuit card assembly, the collimator, and the adaptor.

15. The system of 14 wherein the at least one light emitting diode comprise at least one of:
a Far-UVC Emitter; and
a Nano LED.

16. A data communication system for providing light in an enclosed environment comprising:
a light distribution module comprising a communication input board, a data processing module, a LiFi photocell input, and a LiFi and sanitation output module;
at least one light adaptor fixture further comprising a circuit card assembly, a collimator attached to the at least one fiber distribution line, an adaptor coupled to the circuit card assembly, at least one light emitting diode, and a housing for the circuit card assembly, the collimator, the adaptor, and the light emitting diode; and
at least one fiber distribution line connecting the light distribution module and the at least one fiber adaptor fixture.

17. The system of claim 16 wherein the at least one fiber distribution line further comprises:
a transport fiber.

18. The system of claim 16 further comprising:
at least one wash light emissive fiber.

19. The system of claim 16 wherein the housing further comprises:
an aluminum mechanical enclosure with an electromagnetic interference lip; and
a photo detector on the housing.

20. The system of 16 wherein the enclosed environment comprises the cabin of an aircraft.
